(19) United States
(12) Patent Application Publication
(10) Pub. No.: US 2007/0178023 A1
(43) Pub. Date: Aug. 2, 2007

(54) Method for performing fed-batch operations in small volume reactors

(75) Inventors: A. Peter Russo, Woburn, MA (US); Phil A. Bergman, Arlington, MA (US); Matthew S. Stebulis, Shrewsbury, MA (US); James Hope, Charlestown, MA (US); Timothy J. Johnson, Andover, MA (US); Howard B. Schreyer, Reading, MA (US)

Correspondence Address: WOLF GREENFIELD & SACKS, P.C., 600 ATLANTIC AVENUE, BOSTON, MA, 02210-2206, US

(73) Assignee: BioProcessors Corp., Woburn, MA (US)

(21) Appl. No.: 11/603,950

(22) Filed: Nov. 22, 2006

Related U.S. Application Data
(60) Provisional application No. 60/739,689, filed on Nov. 23, 2005.

(51) Int. Cl. B01J 19/00

(52) U.S. Cl. 422/130

(57) ABSTRACT

Methods for forming chemical and/or biological products in reactors, and/or analyzing chemical and/or biological interactions in reactors are provided. The methods relate, more specifically, to forming such products and/or carrying out such analyses in small volume reactors with control over overall fluid volume in the reactors. The methods can be used to mimic processes in large scale reactors and/or to obtain reaction or interaction information relevant to large scale reactors (e.g., to adjust/optimize large-scale reactor processes). Advantageously, the methods can allow parameters of small scale reactors to be correlated with those of large scale reactors, where desired.

### RELATED APPLICATIONS

This application claims priority under 35 U.S.C. §119(e) to U.S. Provisional Patent Application No. 60/739,689, filed Nov. 23, 2005 by Russo et al., and entitled “Method for Performing Fed-Batch Operations in Small Volume Reactors”.

### FIELD OF INVENTION

The present invention relates to methods for forming chemical and/or biological products in reactors and/or analyzing chemical and/or biological interactions in reactors and, more specifically, to methods for forming chemical and/or biological products and/or analyzing chemical and/or biological interactions in small volume reactors.

### BACKGROUND

Large scale reactions, including large scale bioreactions, are routinely used to produce a variety of end products including, for example, pharmaceutical agents, such as drugs. The reactions typically occur in large scale reactors that are used to contain the reactants and reaction media and to control environmental factors. Often, these reactions use live cells in a bioreactor to produce an end product. Processes in large scale reactors are typically designed to include a growth environment that yields maximum product. Thus, conditions need to be carefully controlled at specific points throughout the reaction. Variations in reaction conditions (parameters) in large scale reactors such as changes in temperature, pH, shear, nutrient levels, metabolite levels and oxygen concentration can have an affect on the efficiency and the outcome of the process. A slight change in one parameter can substantially alter the output of a large scale reaction. While systems are typically designed to control these parameters within a range, there is often enough variation in a system to reduce or alter yields, shorten cell lifetimes or even to upset the reaction process.

In some instances, small scale reactors can be used to learn about reaction conditions and to develop information facilitating the design and/or tuning of large scale reactors. Scaling of small scale reactors to match the conditions of large scale reactors, however, is not trivial; a defined fed-batch operation may be sufficient in a large scale reactor but not in a small scale reactor. For instance, in some fed-batch processes using large scale reactors, cells are grown in a batch regime and the reactor is fed with a solution without the removal of culture fluid. As such, the large scale reactor may contain a low initial volume of fluid. In a small scale reactor, however, a low initial volume may result in shear levels that are detrimental to the health and/or productivity of the cells contained within the reactor.

Methods that could enable parameters of small scale reactors to correlate with those in large scale reactors, and vice versa, would be beneficial.

### SUMMARY OF THE INVENTION

Methods associated with forming chemical and/or biological products in reactors and/or analyzing chemical and/or biological interactions reactors are provided.

In one embodiment of the invention, a method of forming a product in a reaction site and controlling fluid volume in the site is provided. The method comprises providing a reaction site having a reaction site volume of less than 2 mL and containing a first volume of fluid including a reactant, wherein the first volume is greater than 80%, but less than 95%, of the reaction site volume and forming a product from the reactant in the reaction site. The method also includes removing from the reaction site a portion of fluid, homogenous with respect to fluid remaining in the reaction site after removal, such that the concentration of the reactant in the portion removed is substantially equivalent to the concentration of the reactant in the fluid remaining in the reaction site after removal and introducing a second volume of fluid into the reaction site. The volume of fluid remaining in the reaction site, after removing the portion of fluid and introducing the second volume, may be within 10% of the first volume.

In another embodiment of the invention, a method of forming a product in a reaction site and controlling fluid volume in the site is provided. The method comprises providing a reaction site having a reaction site volume of less than 2 mL and containing a first volume of fluid including a reactant, wherein the first volume is greater than 80%, but less than 95%, of the reaction site volume, and forming a product from the reactant in the reaction site. The method also includes introducing a second volume of fluid into the reaction site, and removing a portion of fluid from the reaction site such that the volume of fluid remaining in the reaction site, after removing the portion of fluid and introducing the second volume, is greater than 80% but less than 95% of the reaction site volume.

In another embodiment of the invention, a method of forming a product in a reaction site and controlling fluid volume in the site is provided. The method comprises providing a reaction site having a reaction site volume and containing a first volume of fluid including a reactant and forming a product from the reactant in the reaction site. The method also includes removing from the reaction site a portion of fluid, homogenous with respect to fluid remaining in the reaction site after removal, such that the concentration of the reactant in the portion removed is substantially equivalent to the concentration of the reactant in the fluid remaining in the reaction site after removal, and introducing a second volume of fluid into the reaction site, wherein the second volume is substantially equivalent to the volume of the portion removed so as to maintain the first volume in the reaction site.

In another embodiment of the invention, a method of forming a product in a reaction site and controlling fluid volume in the site is provided. The method comprises providing a reaction site having a reaction site volume of less than 2 mL and containing a first volume of fluid including a reactant, forming a product from the reactant in the reaction site, and removing a portion of fluid from the reaction site. The method also includes introducing a second volume of fluid into the reaction site, wherein the second volume is substantially equivalent to volume of the portion removed so as to maintain the first volume in the reaction site, and maintaining a substantially constant level of shear during the course of forming the product, wherein the substantially constant level of shear is non-zero.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic drawing illustrating a standard fed-batch process used to form a product in a reactor, according to one embodiment of the invention;

FIG. 2 is a schematic drawing illustrating a method of forming a product in a reactor according to another embodiment of the invention;

FIG. 3 is a schematic drawing illustrating another method of forming a product in a reactor according to another embodiment of the invention;

FIG. 4 is a schematic drawing illustrating a reactor, according to another embodiment of the invention;

FIG. 5 is a graph showing a comparison between cell growth in a standard fed-batch process and a “substantially constant volume” process according to another embodiment of the invention;

FIG. 6 is a graph showing a comparison between nutrient and metabolite levels at the end of the processes for the cultures shown in FIG. 5 according to another embodiment of the invention; and

FIG. 7 is a graph showing a comparison between cell growth in a standard fed-batch process and a substantially constant volume process according to another embodiment of the invention.

### DETAILED DESCRIPTION

The present invention relates generally to forming chemical and/or biological products in reactors, and/or analyzing chemical and/or biological interactions in reactors. The invention relates, more specifically, to forming such products and/or carrying out such analyses in small volume reactors with control over overall fluid volume in the reactors. The processes described herein can be used to mimic processes in large scale reactors and/or to obtain reaction or interaction information relevant to large scale reactors (e.g., to adjust/optimize large-scale reactor processes). Advantageously, the methods provided herein can allow parameters of small scale reactors to be correlated with those of large scale reactors, where desired.

The invention relates particularly to fed-batch processes, i.e., processes in which a quantity of liquid is placed within a reaction vessel (as described below, within a “reaction site”), some type of reaction or interaction is allowed to take place within the fluid, an amount of fluid is optionally removed (e.g., to carry out an analysis), an amount of a fluid is added (e.g., to add a new reactant), and the reaction or interaction continues. In such a situation involving a large scale reaction, addition and/or removal of fluid may be very small in amount compared to the volume of the reaction vessel, and therefore may affect the overall reaction volume very little. But in a small scale reaction (e.g., in a microbioreactor), removal and/or addition of fluids during the course of an overall process can relatively largely affect overall fluid volume, and can therefore be disadvantageous where, for one or a variety of reasons, relatively constant fluid volume during the course of an overall reaction (or at least over a portion of steps involved in a reaction) is desired. These principles and modifications are discussed more fully below.

In some embodiments, methods of forming a product from a reactant include introducing a fluid containing a reactant (e.g., a cell) into a reaction site of a reactor and subsequently adding fluid (e.g., a feed) to and removing fluid from the reaction site at prescribed times during the course of forming the product and/or carrying out the analysis (wherever “forming a product” or “carrying out a reaction”, or related language is used in this specification, it is to be understood that the process also can encompass carrying out an analysis of a chemical or biological interaction where a product is not necessarily formed). Certain embodiments involve performing a reaction at optimal volumes (e.g., between 80-95% of the reaction site volume) throughout the course of forming the product. In some instances, the volume of fluid added to the reaction site may be substantially equivalent to the volume of fluid removed from the reaction site so that the final volume of fluid in the reaction site is generally maintained throughout the course of forming the product (i.e., a “substantially constant volume” process).

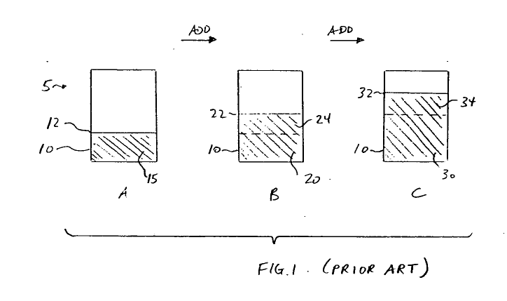

A “large scale reactor” is a reactor that is used to produce a product (e.g., drugs) for sale or for production of an intermediate of a product for sale. Large scale reactors typically have volumes in the range of liters or hundreds of liters or more. In some fed-batch systems involving the use of large scale reactors, feed is introduced into the reactor periodically throughout the reaction. An example of a prior art fed-batch process in a large scale reactor is shown in FIG. 1. Large scale reactor 5 includes a reaction site 10 having an initial volume of fluid 15, which may include a reactant such as a cell (FIG. 1A). During the reaction, portion of fluid 24 can be added to fluid 15 to form fluid 20 (FIG. 1B). Fluid portion 24 may be, for example, a feed comprising nutrients or other components for the cell, which can be used to promote the formation of a product (e.g., a cellular product) in the reaction site. Alternatively or additionally, fluid portion 24 may comprise a component that interacts (e.g., reacts) with the cell. During the reaction, portion of fluid 34 may be added to fluid 20 to form fluid 30 (FIG. 1 C). For instance, fluid portion 34 may comprise more nutrients or components to replace ones that were consumed in the reaction. Thus, the addition of fluid portions can be used to promote a desired effect in the reaction site. To mimic this process in a small scale reactor, in which several additions of fluid into the reactor may not be feasible, fluid (e.g., feed) can be introduced into the reactor with the addition step of removing fluid from the reactor.

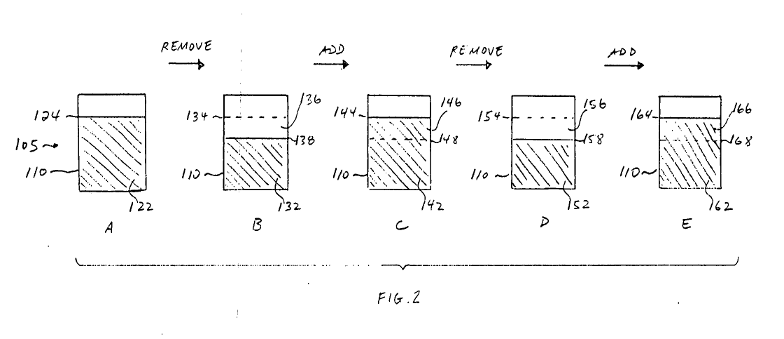

FIG. 2 is a schematic diagram illustrating an example of a process of the invention for forming a product in a reactor involving fluid addition and removal steps, while maintaining substantially constant volume. In the embodiment illustrated in FIG. 2A, reactor 105 includes a reaction site 110 having a reaction site volume and containing fluid 122, which can include a reactant (e.g., a cell) as well as other components (e.g., nutrients for the cell). Fluid 122 is filled to a certain level 124, which may be, for instance, between 80% to 95% of the reaction site volume. While fluid may occupy 80-95% of the reaction site volume, the remaining 5-20% of the reaction site volume may be occupied by one or more immiscible substances such as air (e.g., an air bubble) and/or a solid (e.g., a disc). Such immiscible substances may be used for mixing fluid within the reactor, as described in more detail below. In other embodiments, the fluid may fill 95% to 100% of the reaction site volume.

In some cases, the initial volume of fluid 122 in the reaction site (FIG. 2A) is substantially equivalent to an intermediate volume of fluid in the reaction site (FIG. 2C) and to the final volume of fluid in the reaction site (FIG. 2E). For instance, if the reaction takes place predominately during the “reaction stages” indicated by the stages shown in FIGS. 2A, 2C, and 2E, the reactor can operate at a substantially constant volume throughout the course of the reaction to form the product. (A reaction stage is a stage in which the reaction site contains a certain predetermined volume that allows for optimal reaction conditions.) Alternatively, in other embodiments, fluid volumes in one or more of the reaction stages can differ, resulting in a non-constant volume process. Further descriptions of the substantially constant volume and non-constant volume processes are provided below.

As used herein, a “substantially constant volume” process refers to a process in which a reaction takes place in a reaction site containing one particular volume, or nearly one particular volume, throughout the course of the reaction. In this case, a reactor that contains the reaction site is said to operate at a substantially constant volume.

FIG. 2B shows the removal of fluid portion 136 from reaction site 110, leaving fluid portion 132 remaining in the reaction site. The remaining portion 132 of fluid may fill the reaction site to level 138, which may be less than 90%, less than 70%, less than 50%, or less than 30% of the reaction site volume. The volume of fluid removed from the reaction site will, of course, depend on the particular application and reactive system, as described in more detail below.

The addition of fluid to the reaction site is shown in FIG. 2C. Fluid portion 146 (i.e., the portion between levels 144 and 148) may be added to fluid portion 132 to constitute fluid 142 in the reaction site. In some cases, the volume of fluid 142 may be substantially equivalent to the volume of fluid 122, and fluid level 144 may be substantially equivalent to fluid level 124.

In certain embodiments, after removal of a portion of fluid from the reaction site and introduction of a fluid into the reaction site, the volume remaining in the reaction site is within 10%, 7%, 5%, or 3% of the initial volume of fluid in the reaction site. In other embodiments, the volume remaining in the reaction site is 100% of the initial volume of fluid in the reaction site.

Subsequent removal and addition of fluid can take place in the reaction site, as shown in FIGS. 2D and 2E. In some cases, the volume of fluid portion 156 removed from the reaction site (FIG. 2D) may be substantially equivalent to the volume of fluid portion 136 removed (FIG. 2B). In other cases, the volume of fluid removed at one phase of the reaction can differ from the amount of fluid removed during another phase, i.e., the volume of the fluid portions removed at the stages indicated in FIGS. 2B and 2D can differ. So long as the volumes of fluid in the reaction stages are substantially similar, however, the reaction can be said to undergo a substantially constant volume process.

The volume of fluid removed at any particular stage may depend on the reaction conditions necessary for a particular reaction. For example, in a system in which a toxic bi-product of a reaction is formed as the reaction progresses in time, a small initial volume of fluid may be removed from the reaction site; however, as the reaction progresses and additional bi-product is formed, the bi-product may have a greater toxic effect on the reactant unless a larger amount of fluid is removed at this latter stage. The chemical composition (i.e., the concentrations of the reactants and/or products) and/or amount of a fluid portion removed from the reaction site at one instance can be different, therefore, from the chemical composition and/or amount of a fluid portion removed at another instance.

In some embodiments, the chemical composition of a fluid portion added to a reaction site at one instance is different from the chemical composition of a fluid portion added at another instance. For example, the chemical composition of fluid portion 146 (FIG. 2C) may differ from that of fluid portion 166 (FIG. 2E). This process may be suitable, for example, for performing multi-step reactions in which different reagents are added to the reaction mixture at different stages of the reaction. In other embodiments, the chemical compositions of the fluid portions added to the reaction site at different stages can be substantially similar to one another.

In some cases, fluid can be removed from the reaction site before fluid is added to the reaction site. This approach may be suitable for cases in which, for example, the initial volume of fluid in the reaction site is at a level such that the introduction of additional fluid to the reaction site would cause the reaction site to overfill. Large volumes of fluid (e.g., greater than 15%, greater than 30%, greater than 50%, greater than 70%, or greater than 90% of the reaction site volume) may be removed from the reaction site and this can allow fluid additions to be made in similarly large volumes. In other cases, fluid can be added to the reaction site followed by removal of fluid from the reaction site. Sometimes, this method may be suitable when the volume of fluid to be added and/or removed is relatively small (e.g., 1-15% of the reaction site volume).

In some embodiments, the volume of fluid in the reaction site after removal and addition of fluid can be substantially equivalent. For instance, the volume of fluid 162 (FIG. 2E) can be substantially equivalent to the volume of fluid 142 (FIG. 2C), which can be substantially equivalent to the volume of fluid 122 (FIG. 2A). Generally, the amount of time between addition and removal of fluid in reaction site 110 is short compared to the overall time of the reaction, and minimal product is formed during an in-between stage when a solution is being changed (e.g., at the stages indicated by FIGS. 2B and 2D). The product may be formed predominately during a reaction stage, i.e., when the reaction site contains a certain predetermined volume that allows for optimal reaction conditions. For example, the reaction may take place predominately during the reaction stages indicated by FIGS. 2A, 2C, and 2E and optimal reaction conditions may be present when the reaction site is filled to levels 124, 144, and 164 (and/or within a suitable range of volumes such as between 80-90% of the reaction site volume). By allowing the reaction to proceed during certain stages, reaction conditions can be controlled accurately by the user.

Substantially constant volume reactions/interactions can be important for a variety of reasons. In some applications, the level of shear in a reaction site affects the formation of the product. For instance, shear stress can have a dramatic effect on the behavior of many types of biological cells by altering, e.g., one or more of protein production, gene expression, cell morphology, or likelihood of cell death. Operating the reactor at a substantially constant volume can allow, in some cases, the application of a substantially constant level of shear within the fluid in the reaction site during the course of forming the product. In some cases, the substantially constant level of shear is non-zero. Substantially constant levels of shear can occur, for instance, by maintaining a substantially constant level of an immiscible substance such as a gas, e.g., in the form of an air bubble that can produce shear, in the reaction site, as discussed in more detail below. Those of ordinary skill in the art can appreciate considerations of shear in microreactors especially with reference to U.S. Patent Publication No. 11/147,416, filed Jun. 07, 2005, entitled “Creation of Shear in a Reactor,” by Johnson, et al., which is incorporated herein by reference in its entirety.

In some embodiments, a “homogenous portion” of fluid can be removed from the reaction site; in other words, the fluid removed from the reaction site can be homogeneous with respect to fluid remaining in the reaction site after removal, such that the concentration of a reactant in the portion removed is substantially equivalent to the concentration of the reactant in the fluid remaining in the reaction site after removal. Removing a portion that is homogeneous may be facilitated by mixing the fluid in the reaction site prior to removal. For instance, prior to the removal of portion 156 from reaction site 110 (FIG. 2D), fluid 142 may be mixed such that a reactant is dispersed substantially uniformly (i.e., mixed thoroughly) throughout the reaction site. This act of mixing may cause the concentration of the reactant in portion 156 removed to be substantially equivalent to the concentration of the reactant in fluid portion 152 remaining in the reaction site. Consequently, in certain embodiments, the concentrations of reactants and/or products in the reactor do not change after removal of one or more fluid portions. One advantage of removing a homogeneous portion is that the portion of fluid removed from the reaction site can be a representative sample of the reaction mixture, which can be used for analysis at intermediate time points.

Examples of removing homogeneous portions are as follows. In one embodiment, reactants such as cells are suspended in a fluid in a reaction site during the formation of a product. A fluid portion may be added to the reaction site either before, or after, removing a portion of fluid from the reaction site. In both cases, fluid in the reaction site may be mixed thoroughly prior to fluid removal. Upon removal of a portion of fluid from the reaction site, a portion of the suspended cells can also be removed. In some cases, removal of a homogeneous portion of fluid from the reaction site may include removing a portion of the cell suspension such that the concentration of the cells in the portion removed is substantially equivalent to the concentration of the cells in the portion remaining in the reaction site. In another embodiment, reactants such as cells are attached to a surface in the reaction site (e.g., on a component inside the reaction site or on a wall of the reaction site) and other reactants, such as certain nutrients or drugs, are in solution within the reaction site. In some instances, upon removal of a portion of fluid from the reaction site, a portion of the nutrients or drugs may be removed, but the cells are not removed. The concentration of nutrients or drugs in the portion removed may be substantially equivalent to the concentration of the nutrients or drugs, respectively, remaining in the reaction site.

Methods of the present invention can, in some instances, enable conditions in the reaction site to be substantially uniform throughout the reaction site at any instant time. These methods contrast with some batch processes which involve adding a fresh nutrient solution to the reaction site while withdrawing spent culture solution at the same rate. In the latter case, conditions are continuously changing with time and fluid portions removed are not homogeneous with respect to fluid portions remaining in the reaction site. In some embodiments, methods of the present invention distinguish over certain batch processes which involve removing particular components (e.g., wastes or volatile components), instead of homogeneous portions of fluid, from the reaction site.

A general description of a fed-batch operation is now described. Fed-batch operations are generally described by an initial volume, Vᵢ, which is a certain percentage of the final working volume of the reaction site, V_{f}. One or more fluid portions can be added to the reaction site at specified times during the run of the reaction. These feeds (fluid additions), V_{feed, j}, where j ranges from 1 to the total number of feeds, may generally be given as a specific volume to be added, or may be expressed as a fraction or percentage of the initial volume, a, or as a fraction or percentage of the final volume, b.
V_{feed, j}=a*Vᵢ or V_{feed, j}=b*V_{f} (1)

As described above, the feeds may or may not be of the same chemical composition and/or of the same volume. The final volume is then given as
V_{f}=Vᵢ+ΣV_{feed, j} (2)

It is also possible to write the material balance for each fluid addition:
V(1)=Vᵢ+V_{feed, 1}
V(2)=V(1)+V_{feed, 2} (3)

In this case, the individual feeds may also be expressed as a fraction or percentage of the volume immediately prior to the feed, c, or as a fraction or percentage of the volume immediately after the feed, d.
c=V_{feed, 1}/Vᵢ or d=V_{feed, 1}/V(1) (4)

In certain situations, it may not be possible to perform fed-batch operations in this conventional manner, i.e., to add multiple feeds to the reaction site such that the volume of the fluid in the reaction site increases after each fluid addition. For example, the initial volume, Vᵢ, may be too small to be efficiently mixed, or may result in detrimental levels of shear. In the case of a small scale reactor, e.g., a microbioreactor, the optimal fill volume for appropriate shear levels may be a certain percentage of the reaction site volume. For instance, the optimal fill volume may be 80-85%, 86-90%, 91-95%, or 96-100% of the reaction site volume. These ranges of volumes are much larger than the starting volumes of some fed-batch processes, which typically range from 50-75% or less of the reaction site volume.

In some cases, it is possible to perform an equivalent fed-batch process while maintaining the reaction site volume at its final level, V_{f}. This can be accomplished by converting the volume of the feed used in the standard procedure, V_{feed, 1}, to its equivalent fraction of the reaction site volume immediately after the feed, d, in Eq. (4). Then, a portion of fluid from the reaction site contents equal to this fraction of the reaction site volume can be removed.
V_{removed}=d*V_{f} (5)

In certain embodiments, the portion of fluid removed from the reaction site can be homogeneous with respect to fluid remaining in the reaction site after removal, such that the concentration of a reactant in the portion removed is substantially equivalent to the concentration of the reactant in the fluid remaining in the reaction site after removal. Because the portion removed is a homogeneous sample of the contents of the reaction site, all of the component concentrations remaining in the reaction site can remain substantially the same and only the volume can be reduced. Then, this volume can replaced by the feed.
V_{feed}=V_{removed}=d*V_{f} (6)

In this manner, the feeding strategy can be conserved between the standard fed-batch protocol and the substantially constant volume fed-batch protocol (from Eqs. 4 & 5).
d=V_{feed, 1}/V(1)=V_{removed}/V_{f} (7)

This process can then be repeated for all subsequent feeds and a complete fed-batch process can be performed while maintaining a substantially constant working volume.

A portion of fluid removed from the reaction site can be a representative sample that can be used for analysis at intermediate time points. In some large scale systems, it is often possible to remove a small sample volume that is an insignificant percentage of the reaction site volume. However, in smaller systems, the sample volume required for analysis may often be more than 1% of the total volume. This percentage can be a significant volume and can dramatically affect the outcome of a process if the feeding strategy is not adjusted accordingly. For example, in a 25 mL shake flask, it may be necessary to remove 0.5 mL to measure analyte concentrations. This amount represents 2% of the total system volume and can be a higher percentage of the actual volume in the flask if it is removed at an intermediate time point during a standard fed-batch operation.

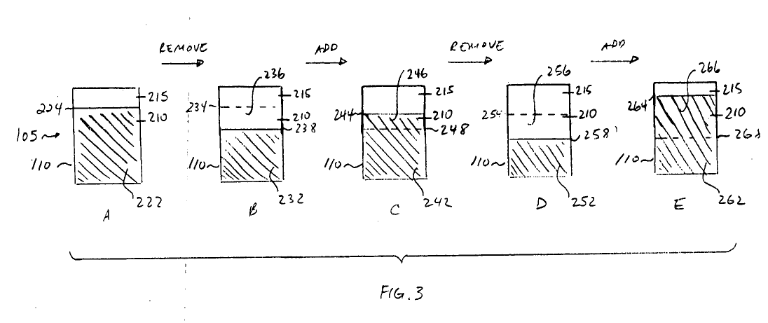

In another embodiment of the invention, a fed-batch process can be carried out in a process where the volume of fluid added to the reaction site is not substantially equivalent to the volume of fluid removed from the reaction site. In other words, the volumes of fluid in the reaction site during each of the reaction stages can vary, resulting in a non-constant volume process. During the course of forming the product, however, fluid in the reaction site may consistently fill the reaction site to a certain volume, e.g., 80-95% of the reaction site volume. For example, after both adding fluid to and removing fluid from the reaction site, the fluid remaining in the reaction site may fill 80-95% of the reaction site volume. FIG. 3 illustrates an example of such a process, where a reaction takes place predominately during the reaction stages indicated by FIGS. 3A, 3C, and 3E.

FIG. 3A shows reaction site 110 containing fluid 222 having a volume indicated by level 224. As illustrated in FIG. 3A, level 224 is between levels 210 and 215. In some instances, the range of volumes between levels 210 and 215 may correspond to optimal reaction volumes within the reaction site, i.e., volumes between 80% and 95% of the reaction site volume, respectively. FIGS. 3B and 3C show the removal of fluid portion 236 (the portion between levels 234 and 238) from the reaction site and the addition of fluid portion 246 (the portion between levels 244 and 248) to the reaction site, respectively. As shown, fluid portions 236 and 246 have different volumes, i.e., the volume of fluid removed is different from the volume of fluid added to the reaction site. As long as the volume of the fluid in the reaction site (i.e., as indicated by level 244 of FIG. 3C) stays between levels 210 and 215 during the reaction stages, the reaction may proceed under optimal volume conditions. Of course, appropriate optimal volume conditions may vary depending on the type of reactor, the specific reaction system including types of reactants, etc. In some embodiments of the invention, such as for certain reactions involving cells, optimal volume conditions include volumes between 80% and 95% of the reaction site volume.

Subsequent removal and addition of fluid portions can also result in different volumes within the reaction site during the reaction stages, i.e., as shown in the removal of portion 256 in FIG. 3D and the addition of portion 266 in FIG. 3E.

Having different volumes of fluids in the reaction site at different reaction stages may be suitable for cases in which, for example, the exact volumes of fluid portions added and/or removed are not critical to the formation of the product, i.e., as long as the volume in the reaction site does not fall below or rise above certain levels during formation of the product (e.g., below or above an optimal volume range). For example, some reactions involving cell cultures may fall within this category.

In some instances, the non-constant volume approach can be used, while maintaining the reaction between an optimal reaction volume range, for cases in which the exact volumes of fluid portions added and/or removed are critical, and/or it is desirable to know the exact volumes added to and/or removed from the reaction site, as long as the volumes added to and removed from a reaction site are recorded after each event. This approach can allow the user to determine appropriate levels of components (e.g., reactants) within the reaction site, even if the volumes of fluid vary between different reaction stages. This method may be suitable for cases in which, for example, a certain volume of fluid (or level of shear) is appropriate at one stage of the reaction, but another volume of fluid (or level of shear) is appropriate at a second stage of the reaction.

In one embodiment, all, or portions, of a fluid in a reactor can be transferred from a region within the reactor to the reaction site (i.e., prior to the reaction taking place and/or during addition of fluid to the reaction site). For instance, certain regions within the reactor may serve as reservoirs, i.e., for reactants, for fluids to be transferred to the reaction site. Certain pre-processing steps, such as filtration of certain components in the fluid, may occur before and/or during transfer of fluid to the reaction site. In another embodiment, all, or portions, of a fluid can be transferred from the reaction site to another region of the reactor, e.g., for a post-processing step such as purification. In some instances, fluid in the reaction site is not transferred to another region or reaction site for further formation of the product during the course of forming the product, i.e., the product is formed in the same reaction site throughout the course of the reaction.

Substantially constant volume and/or non-constant volume methods as described herein may allow, in some instances, parameters (e.g., reactant and/or product concentrations) in a small scale reactor to scale substantially similarly to those of a large scale reactor system, and vice versa, and/or to obtain reaction or interaction information relevant to large scale reactors (e.g., to adjust/optimize large-scale reactor processes). For instance, reaction conditions in a small scale reactor can be maintained within ranges that provide results allowing the reaction conditions to be transferred to large scale reactors with a corresponding effect on large scale reactor results. Therefore, small scale reactors can be used to learn about reaction conditions and to predict information facilitating the design and/or tuning of large scale reactors in some embodiments. Additional examples of correlating parameters in small scale reactors to those of large scale reactors, and vice versa, are described in International Patent Application Serial No. PCT/US2005/045269, filed Dec. 15, 2005, entitled “Methods of Providing Biochemical Analyses,” by Zarur, et al. and International Patent Application Serial No. PCT/US2005/045430, filed Dec. 15, 2005, entitled “Microreactor Simulation of Macroreactor,” by Zarur, et aL., both incorporated herein by reference in their entirety. Embodiments of the present invention may be used to enhance or alter the performance of reactions in a variety of reactors. As used herein, a “reactor” is the combination of components including a reaction site, any chambers (including reaction chambers and ancillary chambers), channels, ports, inlets and/or outlets (i.e., leading to or from a reaction site), sensors, actuators, processors, controllers, membranes, and the like, which, together, operate to promote and/or monitor a biological, chemical, or biochemical reaction, interaction, operation, or experiment at a reaction site, and which can be part of a device. For example, a device may include at least 5, at least 10, at least 20, at least 50, at least 100, at least 500, or at least 1,000 or more reactors. Examples of reactors include chemical or biological reactors and cell culturing devices, as well as the reactors described in International Patent Application Serial No. PCT/US01/07679, published on Sep. 20, 2001 as WO 01/68257, incorporated herein by reference in its entirety. Reactors can include one or more reaction sites or chambers. The reactor may be used for any chemical, biochemical, and/or biological purpose, for example, cell growth, pharmaceutical production, chemical synthesis, hazardous chemical production, drug screening, materials screening, drug development, chemical remediation of warfare reagents, or the like. For example, the reactor may be used to facilitate very small scale culture of cells or tissues. In one set of embodiments, a reactor comprises a matrix or substrate of a few millimeters to centimeters in size, containing channels with dimensions on the order of, e.g., tens or hundreds of micrometers. Reagents of interest may be allowed to flow through these channels, for example to a reaction site, or between different reaction sites, and the reagents may be mixed or reacted in some fashion. The products of such reactions can be recovered, separated, and treated within the system in certain cases.

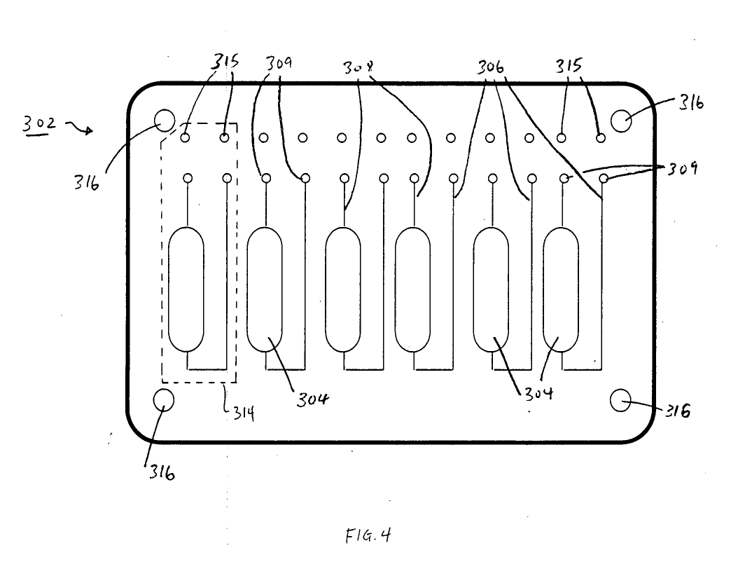

One particular reactor in which methods of the present invention can be performed is shown in FIG. 4. In FIG. 4, each reaction site 304, along with the associated fluidic connections (e.g., channels 306 and 308, ports 309 and ports 315), together define a reactor 314, as indicated by dotted lines. In FIG. 4, six such reactors are shown, each reactor having substantially the same configuration. In other embodiments, a reactor may include more than one reaction site, channels, ports, etc. Additionally, a device layer may have reactors that do not substantially have the same configuration.

In the embodiment illustrated in FIG. 4, a layer 302 which includes within it a series of void spaces which, when layer 302 is positioned between two layers (a top and bottom layer relative to the plane of FIG. 4, not shown) define a series of enclosed channels and reaction sites. The overall arrangement into which layer 302 can be assembled to form a device will be understood more clearly from the description below.

FIG. 4 represents an embodiment including six reaction sites 304 (analogous to, for example, reaction site 110 of FIG. 2). Reaction sites 304 define a series of generally aligned, elongated, rounded rectangular voids within a relatively thin, generally planar piece of material defining layer 302. Reaction sites 304 can be addressed by a series of channels including channels 306 for delivering components to reaction sites 304 and channels 308 for removal of components from the reaction sites. Of course, any combination of channels can be used to deliver and/or remove components from the reaction sites. For example, channels 308 can be used to deliver components to the reaction sites while channels 306 can be used to remove components, etc. Although shown as lines in FIG. 4, channels 306 and 308 are to be understood to define voids within layer 302 which, when covered above and/or below by other layers, may become enclosed channels. Each of channels 306 and 308, in the embodiment illustrated in FIG. 4, is addressed by a port 309. Where port 309 is connected to an inlet channel it can define an inlet port, and where fluidly connected to an outlet channel it can define an outlet port. In the embodiment illustrated, port 309 is a void that is larger in width than the width of channels 306 or 308. Those of ordinary skill in the art will recognize a variety of techniques for accessing ports 9 and utilizing them to introduce components into channels, and/or remove components from channels addressed by those ports. As one example, port 309 can be a “self-sealing” port, addressable by a needle (as described more fully below) when at least one side of port 309 is covered by a layer (not shown) of material which, when a needle is inserted through the material and withdrawn, forms a seal generally impermeable to components such as fluids introduced into or removed from the device via the port.

Also shown in FIG. 4 are a series of ports 315, not shown to be fluidly connected or connectable to any inlet channels, outlet channels, or reaction sites of the device. Ports 315 can be defined by voids in layer 302 (which may serve as a single device), and can optionally be used to facilitate fluidic connection between and among various layers of a device and/or an environment external to the device. As an example, where layer 302 forms part of a multi-layer device including multiple reaction sites in different layers, another layer may be provided on one side of layer 302 (optionally separated by an intermediate layer or layers) including one set of reaction sites or conduits, and another layer may be provided on the opposite side of layer 302, similarly separated by intermediate layers if desirable, and ports 315 may define passages or routes for fluidic connection between reaction sites and/or conduits of device layers on opposite sides of layer 302. Ports 315 also may connect to channels communicating with an auxiliary chamber aligned with a chamber defining reaction site 304, separated from the reaction site by a membrane, e.g., semi-permeable membrane. In this way, fluid can be independently flowed into, out of, and/or through a space on one side of a membrane, and also independently through a space on the other side of the membrane, one or both defining a chamber and/or reaction site. For example, in one embodiment, reactor 314 can include reaction site 304 which can be defined as a volume within a container or reactor, positioned with respect to an auxiliary chamber such that components and/or fluid can be transferred from the reaction site to the auxiliary chamber, and or from the auxiliary chamber to the reaction site. In one arrangement, the reaction site and auxiliary chamber are adjacent, and a semi-permeable membrane separates the reaction site and auxiliary chamber. Fluid containing reactants (e.g., cells) may be positioned in the reaction site and fluid (optionally, without reactants) may be positioned in the auxiliary chamber via one or more ports of the auxiliary chamber. Methods described herein regarding addition and/or removal of fluid may involve removing fluid from, or adding fluid to, the reaction site either via a port connected to the reaction site and/or across a membrane separating the reaction site from the auxiliary chamber. Where the auxiliary chamber is fed by a port connected to the auxiliary chamber, fluid can be introduced through the port into the auxiliary chamber, selected to contain at least one component (e.g., a nutrient) which diffuses across the membrane. The reaction site and/or chamber may also contain one or more shear-generating elements as needed. Other arrangements are described in International Patent Application Serial No. PCT/US03/25956, published on Feb. 26, 2004 as WO 2004/016727, and International Patent Application Serial No. PCT/US02/11422, published on Oct. 24, 2004 as WO 02/083852, both of which are incorporated herein by reference in their entirety.

Additionally shown in FIG. 4 is a series of devices 316 which can be used to secure layer 302 to other layers of a device and/or to assure alignment of layer 302 with other layers and/or other systems to which the device is desirably coupled. Devices 316 can define screws, posts, indentations (i.e., that match corresponding protrusions of other layers or devices), or the like. Those of ordinary skill in the art are aware of a variety of suitable techniques for securing layers to other layers and/or devices to other components or systems using devices such as these.

In some embodiments, a reactor, such as reactor 105 of FIG. 2 or reactor 314 of FIG. 4, can be a small scale reactor. For instance, the reactor may have a reaction site volume of less than 10 mL, less than 2 mL, less than 1.5mL, less than 1 mL, or less than 100 μL. In other embodiments, methods described herein can be used in a reactor having a large reaction site volume, e.g., greater than 10 mL, greater than 100 mL, greater than 1 L, or greater than 10 L.

As used herein, a “reaction site” is defined as a site within a reactor that is constructed and arranged to produce a physical, chemical, biochemical, and/or biological reaction during use of the reactor. More than one reaction site may be present within a reactor or a device in some cases, for example, at least one reaction site, at least two reaction sites, at least three reaction sites, at least four reaction sites, at least 5 reaction sites, at least 7 reaction sites, at least 10 reaction sites, at least 15 reaction sites, at least 20 reaction sites, at least 30 reaction sites, at least 40 reaction sites, at least 50 reaction sites, at least 100 reaction sites, at least 500 reaction sites, or at least 1,000 reaction sites or more may be present within a reactor or a device. The reaction site may be defined as a region where a reaction is allowed to occur; for example, the reactor may be constructed and arranged to cause a reaction within a channel, one or more chambers, at the intersection of two or more channels, etc. The reaction may be, for example, a mixing or a separation process, a reaction between two or more chemicals, a light-activated or a light-inhibited reaction, a biological process, and the like. In some embodiments, the reaction may involve an interaction with light that does not lead to a chemical change, for example, a photon of light may be absorbed by a substance associated with the reaction site and converted into heat energy or re-emitted as fluorescence. In certain embodiments, the reaction site may also include one or more cells and/or tissues. Thus, in some cases, the reaction site may be defined as a region surrounding a location where cells are to be placed within the reactor, for example, a cytophilic region within the reactor.

In some cases, the reaction site containing cells may include a region containing a gas (e.g., a “gas head space”); for example, a gas head space may be present when the reaction site is not completely filled with a liquid. The gas head space, in some cases, may be partially separated from the reaction site, through use of a gas-permeable or semi-permeable membrane, or through the use of certain impediments (e.g., posts) within or adjacent to the reaction site. In some cases, the gas head space may include various sensors for monitoring temperature, and/or other reaction conditions.

In certain embodiments, the gas head space may be used to generate shear within the reactor. For example, a gas bubble can be used within a reaction site or container of a reactor as a shear-generating element such that movement of the gas bubble creates shear stress within the reaction site. In some embodiments, the gas bubble is disposed in a reaction site and is moved relative to a liquid sample present within the reaction site by reorienting the reaction site (e.g., by using a rotating apparatus that is configured to secure the reactor containing the reaction site in any of a variety of suitable orientations). A density difference between the immiscible substance and the liquid sample results in the movement of the immiscible substance via gravitational and/or centrifugal forces.

In other embodiments, an immiscible substance, such as an immiscible liquid or a solid (e.g., a disc), is moveable within the reaction site and is used within the reaction site as a shear-generating element such that movement of the immiscible substance creates shear stress within the reaction site. In some embodiments, the immiscible substance is not integrally connected to the reaction site. As used herein, “immiscible” defines a relationship between two substances that are largely immiscible with respect to each other, but can be partially miscible. “Immiscible” substances, even if somewhat miscible with each other, will largely remain separate from each other in an observable division. For example, air and water meet this definition, in that a reactor described herein containing primarily water or an aqueous solution and some air will largely phase-separate into an aqueous portion and a gas bubble or gas region, even though air is slightly soluble in water and water vapor may be present in the air. Other examples of immiscible substances, albeit those that may be somewhat miscible with each other, include oil and water, a polymeric bead and water, a polymeric disc and water, and the like. In certain embodiments, movement of the immiscible substance within the reaction site can be controlled externally.

An immiscible substance may occupy various volumes within the reaction site. For example, an immiscible substance may occupy less than 20%, less than 15%, less than 10%, or less than 5% of the reaction site volume, and the remaining volume of the reaction site may be filled with a fluid containing a reactant. That is, the sum of the volume of the fluid containing the reactant and volume of the immiscible substance may be substantially equivalent to the reaction site volume. In one particular embodiment, a reaction site having a volume of 2 mL contains between 1.6-1.9 mL of an initial volume of fluid and the remaining volume within the reaction site (e.g., 0.4-0.1 mL) is occupied by an air bubble or a solid disc.

Movement of an immiscible substance or other shear-generating element along a path of motion within a reaction site containing a liquid sample may apply shear stress to components, such as cells, within the liquid sample. Movement of a shear-generating element along a path of motion intersecting with a first location within the reaction site and a second location within the reaction site defines a motion that is not purely, nor, in certain embodiments, even primarily rotational, unlike rotating stir bars which can also create shear. The first and second locations within the reaction site may be the same location, such that the shear-generating element moves along a path of motion that starts and ends at the same location. A path of motion may be curved and/or linear. In certain embodiments, the path of motion may be defined by the shape of the reaction site; therefore, the shape of the reaction site can be chosen accordingly.

In some embodiments, shear-generating elements within a reactor may be controlled by a control system, such as a computer-implemented process control system, in operative association with the reactor and configured for moving and/or controlling the movement of the shear-generating element via, for example, the application of external force(s) such as gravitational, centrifugal, mechanical, pneumatic, hydraulic, magnetic, and/or electrical forces. For example, one or more discs that respond to magnetic and/or electric fields may be placed in a reaction site. A controlled application of a magnetic and/or electrical field may be used to move such disc(s) within the reaction site. Shear-generating elements that are moved by forces other than gravity/buoyancy can be the same density as the liquid within which they are contained. In some embodiments, a single controlled magnetic or electrical field may be used to move discs within numerous reaction sites. Such embodiments may reduce the number of moving components of the overall system. Specifically, the ability to reduce or eliminate the movement of the reaction site while generating shear may allow for easier application of measurement techniques, such as optical measurement techniques, to the liquid samples.

Many embodiments and arrangements of the invention are described with reference to a device, chip, or to a reactor, and those of ordinary skill in the art will recognize that the invention can apply to each or all. For example, a channel arrangement may be described in the context of one, but it will be recognized that the arrangement can apply in the context of the other (or, typically, both: a reactor which is part of a device). It is to be understood that all descriptions herein that are given in the context of a reactor or device apply to the other, unless inconsistent with the description of the arrangement in the context of the definitions of “device” and “reactor” herein.

In some embodiments, the reaction site may be defined by geometrical considerations. For example, the reaction site may be defined as a chamber in a reactor, a channel, an intersection of two or more channels, or other location defined in some fashion (e.g., formed or etched within a substrate that can define a reactor and/or device). Other methods of defining a reaction site are also possible. In some embodiments, the reaction site may be artificially created, for example, by the intersection or-union of two or more fluids (e.g., within one or several channels), or by constraining a fluid on a surface, for example, using bumps or ridges on the surface to constrain fluid flow. In other embodiments, the reaction site may be defined through electrical, magnetic, and/or optical systems. For example, a reaction site may be defined as the intersection between a beam of light and a fluid channel.

In some cases, cells can be present at the reaction site. Sensor(s) associated with the device or reactor, in certain cases, may be able to determine the number of cells, the density of cells, the status or health of the cell, the cell type, the physiology of the cells, etc. In certain cases, the reactor can also maintain or control one or more environmental factors associated with the reaction site, for example, in such a way as to support a chemical reaction or a living cell. In one set of embodiments, a sensor may be connected to an actuator and/or a microprocessor able to produce an appropriate change in an environmental factor within the reaction site. The actuator may be connected to an external pump, the actuator may cause the release of a substance from a reservoir, or the actuator may produce sonic or electromagnetic energy to heat the reaction site, or selectively kill a type of cell susceptible to that energy. The reactor can include one or more than one reaction site, and one or more than one sensor, actuator, processor, and/or control system associated with the reaction site(s). It is to be understood that any reaction site or a sensor technique disclosed herein can be provided in combination with any combination of other reaction sites and sensors.

As used herein, a “channel” is a conduit associated with a reactor and/or a device (within, leading to, or leading from a reaction site) that is able to transport one or more fluids specifically from one location to another, for example, from an inlet of the reactor or device to a reaction site, e.g., as further described below. Materials (e.g., fluids, cells, particles, etc.) may flow through the channels, continuously, randomly, intermittently, etc. The channel may be a closed channel, or a channel that is open, for example, open to the external environment surrounding the reactor or device containing the reactor. The channel can include characteristics that facilitate control over fluid transport, e.g., structural characteristics (e.g., an elongated indentation), physical/chemical characteristics (e.g., hydrophobicity vs. hydrophilicity) and/or other characteristics that can exert a force on a fluid when within the channel. The fluid within the channel may partially or completely fill the channel. In some cases the fluid may be held or confined within the channel or a portion of the channel in some fashion, for example, using surface tension (i.e., such that the fluid is held within the channel within a meniscus, such as a concave or convex meniscus). The channel may have any suitable cross-sectional shape that allows for fluid transport, for example, a square channel, a circular channel, a rounded channel, a rectangular channel (e.g., having any aspect ratio), a triangular channel, an irregular channel, etc. The channel may be of any size within the reactor or device. For example, the channel may have a largest dimension perpendicular to a direction of fluid flow within the channel of less than about 1000 micrometers in some cases, less than about 500 micrometers in other cases, less than about 400 micrometers in other cases, less than about 300 micrometers in other cases, less than about 200 micrometers in still other cases, less than about 100 micrometers in still other cases, or less than about 50 or 25 micrometers in still other cases. In some embodiments, the dimensions of the channel may be chosen such that fluid is able to freely flow through the channel, for example, if the fluid contains cells. The dimensions of the channel may also be chosen in certain cases, for example, to allow a certain volumetric or linear flowrate of fluid within the channel. In one embodiment, the depth of other largest dimension perpendicular to a direction of fluid flow may be similar to that of a reaction site to which the channel is in fluid communication with. Of course, the number of channels, the shape or geometry of the channels, and the placement of channels within the device can be determined by those of ordinary skill in the art.

Devices may also include a plurality of inlets and/or outlets that can receive and/or output any of a variety of reactants, products, and/or fluids, for example, directed towards one or more reactors and/or reaction sites. In some cases, the inlets and/or outlets may allow the aseptic transfer of compounds. At least a portion of the plurality of inlets and/or outlets may be in fluid communication with one or more reaction sites within the device. In some cases, the inlets and/or outlets may also contain one or more sensors and/or actuators, as further described below. Essentially, the device may have any number of inlets and/or outlets from one to tens of hundreds that can be in fluid communication with one or more reactors and/or reaction sites. Less than 5 or 10 inlets and/or outlets may be provided to the reactor and/or reaction site(s) for certain reactions, such as biological or biochemical reactions. In some cases each reactor may have around 25 inlets and/or outlets, in other cases around 50 inlets and/or outlets, in still other cases around 75 inlets and/or outlets, or around 100 or more inlets and/or outlets in still other cases.

As one example, the inlets and/or outlets of the device, directed to one or more reactors and/or reaction sites may include inlets and/or outlets for a fluid such as a gas or a liquid, for example, for a waste stream, a reactant stream, a product stream, an inert stream, etc. In some cases, the device may be constructed and arranged such that fluids entering or leaving reactors and/or reaction sites do not substantially disturb reactions that may be occurring therein. For example, fluids may enter and/or leave a reaction site without affecting the rate of reaction in a chemical, biochemical, and/or biological reaction occurring within the reaction site, or without disturbing and/or disrupting cells that may be present within the reaction site. Examples of inlet and/or outlet gases may include, but are not limited to, CO₂, CO, oxygen, hydrogen, NO, NO₂, water vapor, nitrogen, ammonia, acetic acid, etc. As another example, an inlet and/or outlet fluid may include liquids and/or other substances contained therein, for example, water, saline, cells, cell culture medium, blood or other bodily fluids, antibodies, pH buffers, solvents, hormones, carbohydrates, nutrients, growth factors, therapeutic agents (or suspected therapeutic agents), antifoaming agents (e.g., to prevent production of foam and bubbles), proteins, antibodies, and the like. The inlet and/or outlet fluid may also include a metabolite in some cases. A “metabolite,” as used herein, is any molecule that can be metabolized by a cell. For example, a metabolite may be or include an energy source such as a carbohydrate or a sugar, for example, glucose, fructose, galactose, starch, corn syrup, and the like. Other example metabolites include hormones, enzymes, proteins, signaling peptides, amino acids, etc.

The inlets and/or outlets may be formed within the device by any suitable technique known to those of ordinary skill in the art, for example, by holes or apertures that are punched, drilled, molded, milled, etc. within the device or within a portion of the device, such as a substrate layer. In some cases, the inlets and/or outlets may be lined, for example, with an elastomeric material. In certain embodiments, the inlets and/or outlets may be constructed using self-sealing materials that may be re-usable in some cases. For example, an inlet and/or outlet may be constructed out of a material that allows the inlet and/or outlet to be liquid-tight (i.e., the inlet and/or outlet will not allow a liquid to pass therethrough without the application of an external driving force, but may admit the insertion of a needle or other mechanical device able to penetrate the material under certain conditions). In some cases, upon removal of the needle or other mechanical device, the material may be able to regain its liquid-tight properties (i.e., a “self-sealing” material). Non-limiting examples of self-sealing materials suitable for use with the invention include, for example, polymers such as polydimethylsiloxane (“PDMS”), natural rubber, HDPE, or silicone materials such as Formulations RTV 108, RTV 615, or RTV 118 (General Electric, New York, N.Y.).

In some embodiments, the device includes very small elements, for example, sub-millimeter or microfluidic elements. For example, in some embodiments, the device may include at least one reaction site having a cross sectional dimension of no greater than, for example, 100 mm, 80 mm, 50 mm, or 10 mm. In some embodiments, the reaction site may have a maximum cross section no greater than, for example, 100 mm, 80 mm, 50 mm, or 10 mm. As used herein, the “cross section” refers to a distance measured between two opposed boundaries of the reaction site, and the “maximum cross section” refers to the largest distance between two opposed boundaries that may be measured. In other embodiments, a cross section or a maximum cross section of a reaction site may be less than 5 mm, less than 2 mm, less than 1 mm, less than 500 micrometers, less than 300 micrometers, less than 100 micrometers, less than 10 micrometers, or less than 1 micrometer or smaller. As used herein, a “microfluidic device” is a device comprising at least one fluidic element having a sub-millimeter cross section, i.e., having a cross section that is less than 1 mm. As one particular non-limiting example, a reaction site may have a generally rectangular shape, with a length of 80 mm, a width of 10 mm, and a depth of 5 mm.

While one reaction site may be able to hold and/or react a small volume of fluid as described herein, the technology associated with the invention also allows for scalability and parallelization. With regard to throughput, an array of many reactors and/or reaction sites within a device, or within a plurality of devices, can be built in parallel to generate larger capacities. For example, a plurality of devices (e.g. at least about 10 devices, at least about 30 devices, at least about 50 devices, at least about 75 devices, at least about 100 devices, at least about 200 devices, at least about 300 devices, at least about 500 devices, at least about 750 devices, or at least about 1,000 devices or more) may be operated in parallel, for example, through the use of robotics, for example which can monitor or control the devices automatically. Additionally, an advantage may be obtained by maintaining production capacity at the small scale of reactions typically performed in the laboratory, with scale-up via parallelization. Many reaction sites may be arranged in parallel within a reactor of a device and/or within a plurality of devices. Specifically, at least five reaction sites can be constructed to operate in parallel, or in other cases at least about 7, about 10, about 30, about 50, about 100, about 200, about 500, about 1,000, about 5,000, about 10,000, about 50,000, or even about 100,000 or more reaction sites can be constructed to operate in parallel, for example, in a high-throughput system. In some cases, the number of reaction sites may be selected so as to produce a certain quantity of a species or product, or so as to be able to process a certain amount of reactant. In certain cases the parallelization of the devices and/or reactors may allow many compounds to be screened simultaneously, or many different growth conditions and/or cell lines to be tested and/or screened simultaneously. Of course, the exact locations and arrangement of the reaction site(s) within the reactor or device will be a function of the specific application.

Additionally, any embodiment described herein can be used in conjunction with a collection chamber connectable ultimately to an outlet of one or more reactors and/or reaction sites of a device. The collection chamber may have a volume of greater than 10 milliliters or 100 milliliters in some cases. The collection chamber, in other cases, may have a volume of greater than 100 liters or 500 liters, or greater than 1 liter, 2 liters, 5 liters, or 10 liters. Large volumes may be appropriate where the reactors and/or reaction sites are arranged in parallel within one or more devices, e.g., a plurality of reactors and/or reaction sites may be able to deliver a product to a collection chamber.

Devices can be constructed and arranged such that they are able to be stacked in a predetermined, pre-aligned relationship with other, similar devices, such that the devices are all oriented in a predetermined way (e.g., all oriented in the same way) when stacked together. When a device is designed to be stacked with other, similar devices, the device often can be constructed and arranged such that at least a portion of the device, such as a reaction site, is in fluidic communication with one or more of the other devices and/or reaction sites within other devices. This arrangement may find use in parallelization of devices, as discussed herein.

Devices may also be constructed and arranged such that at least one reaction site and/or reactor of the device is in fluid communication with, and/or chemically, biologically, or biochemically connectable to an apparatus constructed and arranged to address at least one well of a microplate, for example, an apparatus that can add species to and/or remove species from wells of microplates, and/or can test species within wells of a microplate. In this arrangement, the apparatus may add and/or remove species to/from a reaction site of a device, and/or test species at reaction sites. In this embodiment, the reaction sites typically are arranged in alignment with wells of the microplate.

Devices can be substantially liquid-tight in one set of embodiments. As used herein, a “substantially liquid-tight device” or a “substantially liquid-tight reactor” is a device or reactor, respectively, that is constructed and arranged, such that, when the device or reactor is filled with a liquid such as water, the liquid is able to enter or leave the device or reactor solely through defined inlets and/or outlets of the device or reactor, regardless of the orientation of the device or reactor, when the device is assembled for use. In this set of embodiments, the device is constructed and arranged such that when the device or reactor is filled with water and the inlets and/or outlets sealed, the device or reactor has an evaporation rate of less than about 100 microliters per day, less than about 50 microliters per day, or less than about 20 microliters per day. In certain cases, a device or reactor will exhibit an unmeasurable, non-zero amount of evaporation of water per day. The substantially liquid-tight device or reactor can have a zero evaporation rate of water in other cases.

Devices can be fabricated using any suitable manufacturing technique for producing a device having one or more reactors, each having one or multiple reaction sites, and the device can be constructed out of any material or combination of materials able to support a fluidic network necessary to supply and define at least one reaction site. Non-limiting examples of microfabrication processes include wet etching, chemical vapor deposition, deep reactive ion etching, anodic bonding, injection molding, hot pressing, and LIGA. For example, the device may be fabricated by etching or molding silicon or other substrates, for example, via standard lithographic techniques. The device may also be fabricated using microassembly or micromachining methods, for example, stereolithography, laser chemical three-dimensional writing methods, modular assembly methods, replica molding techniques, injection molding techniques, milling techniques, and the like as are known by those of ordinary skill in the art. The device may also be fabricated by patterning multiple layers on a substrate (which may be the same or different), for example, as further described below, or by using various known rapid prototyping or masking techniques. Examples of materials that can be used to form devices include polymers, silicones, glasses, metals, ceramics, inorganic materials, and/or a combination of these. The materials may be opaque, semi-opaque translucent, or transparent, and may be gas permeable, semi-permeable or gas impermeable. In some cases, the device may be formed out of a material that can be etched to produce a reactor, reaction site and/or channel. For example, the device may comprise an inorganic material such as a semiconductor, fused silica, quartz, or a metal. The semiconductor material may be, for example, but not limited to, silicon, silicon nitride, gallium arsenide, indium arsenide, gallium phosphide, indium phosphide, gallium nitride, indium nitride, other Group III/V compounds, Group II/VI compounds, Group III/V compounds, Group IV compounds, and the like, for example, compounds having three or more elements. The semiconductor material may also be formed out of combination of these and/or other semiconductor materials known in the art. In some cases, the semiconductor material may be etched, for example, via known processes such as lithography. In certain embodiments, the semiconductor material may have the from of a wafer, for example, as is commonly produced by the semiconductor industry.

In some embodiments, a device may be formed from or include a polymer, such as, but not limited to, polyacrylate, polymethacrylate, polycarbonate, polystyrene, polyethylene, polypropylene, polyvinylchloride, polytetrafluoroethylene, a fluorinated polymer, a silicone such as polydimethylsiloxane, polyvinylidene chloride, bis-benzocyclobutene (“BCB”), a polyimide, a fluorinated derivative of a polyimide, or the like. Combinations, copolymers, or blends involving polymers including those described above are also envisioned. The device may also be formed from composite materials, for example, a composite of a polymer and a semiconductor material.

In some embodiments, the device, or at least a portion thereof, is rigid, such that the device is sufficiently sturdy in order to be handled by commercially-available microplate-handling equipment, and/or such that the device does not become deformed after routine use. Those of ordinary skill in the art are able to select materials or a combination of materials for device construction that meet this specification, while meeting other specifications for use for which a particular device is intended. In other embodiments, however, the device may be serni-rigid or flexible.

In certain embodiments, the device may include a sterilizable material. For example, the device may be sterilizable in some fashion to kill or otherwise deactivate biological cells (e.g., bacteria), viruses, etc. therein, before the device is used or re-used. For instance, the device may be sterilized with chemicals, radiated (for example, with ultraviolet light and/or ionizing radiation), heat-treated, or the like. Appropriate sterilization techniques and protocols are known to those of ordinary skill in the art. For example, in one embodiment, the device is autoclavable, i.e., the device is constructed and arranged out of materials able to withstand commonly-used autoclaving conditions (e.g., exposure to temperatures greater than about 100° C. or about 120° C., often at elevated pressures, such as pressures of at least one atmosphere), such that the device, after sterilization, does not substantially deform or otherwise become unusable. Other examples of sterilization techniques include exposure to ozone, alcohol, phenolics, halogens, heavy metals (e.g., silver nitrate), detergents, quaternary ammonium components, ethylene oxide, CO₂, aldehydes, etc. In another embodiment, the device is able to withstand ionizing radiation, for example, short wavelength, high-intensity radiation, such as gamma rays, electron-beams, or X-rays. In some cases, ionizing radiation may be produced from a nuclear reaction, e.g., from the decay of ⁶⁰Co or ¹³⁷Cs.

In one set of embodiments, at least a portion of the device may be fabricated without the use of adhesive materials. For example, at least two components of a device (e.g., two layers of the device if the device is a multi-layered structure, a layer or substrate of the device and a membrane, two membranes, an article of the device and a component of a microfluidic system, etc.) may be fastened together without the use of an adhesive material. For example, the components may be connected by using methods such as heat sealing, sonic welding, via application of a pressure-sensitive material, and the like. In one embodiment, the components may be held in place mechanically. For example, screws, posts, cantilevers, matching indentations, etc. may be used to mechanically hold the device (or a portion thereof) together. In other embodiments, the two components of the device may be joined together using techniques such as, but not limited to, heat-sealing methods (e.g., or more components of the device may be heated to a temperature greater than the glass transition temperature or the melting temperature of the component before being joined to other components), or sonic welding techniques (e.g., vibration energy such as sound energy may be applied to one or more components of the device, allowing the components to at least partially liquefy or soften).

In one embodiment, two components of the device may be fastened via a heat-sealing method. For example, one or more components of the device may be heated to a temperature greater than the glass transition temperature or the melting temperature of the component (i.e., temperatures at which the component softens or begins to liquefy). The components can be placed in contact with each other and allowed to cool to below the glass transition temperature or the melting temperature, thus allowing the components to become fastened together.

In another embodiment, the two components can be fastened via, sonic welding techniques. As one example, vibration energy (e.g., sound energy) may be applied to one or more components of the device. The applied vibration energy causes the component(s), or at least a portion of the component(s), to at least partially liquefy or soften. The components can then be placed together. The vibration energy may then be stopped, thus allowing the components to become fastened together. In some cases, the components may be designed such that the vibration energy is able to be concentrated into certain regions of the component (an “energy director” region), such that only the energy director region of the component is able to liquefy under the influence of the vibration energy.

In another set of embodiments, two or more components of the device may be joined using an adhesive material. As used herein, an “adhesive material” is given its ordinary meaning as used in the art, i.e., an auxiliary material able to fasten or join two other materials together. Non-limiting examples of adhesive materials suitable for use with the invention include silicone adhesives such as pressure-sensitive silicone adhesives, neoprene-based adhesives, and latex-based adhesives. The adhesive may be applied to one or more components of the device using any suitable method, for example, by applying the adhesive to a component of the device as a liquid or as a semi-solid material such as a viscoelastic solid. For example, in one embodiment, the adhesive may be applied to the component(s) using transfer tape (e.g., a tape having adhesive material attached thereto, such that, when the tape is applied to the component, the adhesive, or at least a portion of the adhesive, remains attached to the component when the tape is removed from the component). In one set of embodiments, the adhesive may be a pressure-sensitive adhesive, i.e., the material is not normally or substantially adhesive, but becomes adhesive and/or increases its adhesive strength under the influence of pressure, for example, a pressure greater than about 6 atm or about 13 atm (about 100 psi or about 200 psi). Non-limiting examples of pressure-sensitive adhesives include AR Clad 7876 (available from Adhesives Research, Inc., Glen Rock, Pa.) and Trans-Sil Silicone PSA NT-1001 (available from Dielectric Polymers, Holyoke, Mass.)

In another embodiment, the adhesive may be applied to at least a component of the device using a solvent-bonding system. In a solvent-bonding system, one or more components of the device are placed in an environment rich in solvent vapor, i.e., the environment that the component(s) is placed in is saturated or supersaturated with a solvent, such that the solvent is able to condense onto the component(s) placed within the environment under suitable conditions (e.g., when the pressure and/or the temperature is lowered). The components can then be contacted together within the environment and allowed to fasten together, for example, when the environment (including solvent) is removed. As one specific example, two polycarbonate components of a device may be fastened together in a methylene chloride environment. For example, a thin layer of a solvent, i.e. methylene chloride or the like, may be applied to a surface. The two surfaces to be joined may then be pressed and/or clamped together under pressure to ensure bonding.

In some embodiments, the device may be constructed and arranged such that one or more reaction sites can be defined, at least in part, by two or more components fastened together as previously described (i.e., with or without an adhesive). In some cases, a reaction site may be free of any adhesive material adjacent to or otherwise in contact with one or more surfaces defining the reaction site, and this can be advantageous, for instance, when an adhesive might otherwise leach into fluid at the reaction site. Of course, an adhesive may be used elsewhere in the device, for example, in other reaction sites. Similarly, in certain cases, a reaction site may be constructed using adhesive materials, such that at least a portion of the adhesive material used to construct the reaction site remains within the device such that it is adjacent to or otherwise remains in contact with one or more surfaces defining the reaction site. Of course, other components of the device may be constructed without the use of adhesive materials, as previously discussed.

One or more sensors, processors, and/or actuators (not shown) can optionally be included in sensing or actuating communication with the device, respectively. “Sensing communication” and “actuating communication,” as used herein, means that a sensor or actuator, respectively, is positioned anywhere in association with the device such that the environment of the reaction site and/or the content of the reaction site can be determined and/or controlled. A sensor or actuator can be included within the device, for example embedded within or integrally connected to the reaction site, positioned within or on the device, or positioned remotely from the device but with physical, electrical, and/or optical connection with the reaction site so as to be able to sense or actuate a factor within the reaction site. For example, a sensor may be free of any physical connection with a device, but may be positioned so as to detect the results of interaction of electromagnetic radiation, such as infrared, ultraviolet, or visible light, which has been directed toward a reaction site and has passed through the site or has been reflected or diffracted by the site. As another example, a sensor may be positioned on or within a device, and may sense activity at a reaction site by being connected optically to the reaction site via a waveguide. The device can be similarly directly or indirectly connected to a network or a control system for overall control of detection and actuation. Sensing and actuating communication can also be provided where the reaction site is in communication with a sensor or actuator fluidly, optically or visually, thermally, pneumatically, electronically, or the like, so as to be able to sense a condition of the reaction site and/or the content of the site. As one example, the sensor may be positioned downstream of one of the outlets, or behind a membrane or a transparent cover separating the reaction site from the sensor.

Devices can be constructed and arranged so as to be able to detect or determine one or more environmental conditions associated with a reaction site of the reactor, for example, using a sensor. In some cases, each reaction site may be independently determined. Detection of the environmental condition may occur, for example, by means of a sensor which may be positioned within the reaction site, or positioned proximate the reaction site, i.e., positioned such that the sensor is in communication with the reaction site in some manner. In some cases, such detection may occur in real-time. The sensor may be, for example, a pH sensor, an optional sensor, an oxygen sensor, a sensor able to detect the concentration of a substance, or the like. Other examples of sensors are further described below. The sensor may be embedded and integrally connected with the device (e.g., within a component defining at least a portion of the reaction site a channel in fluidic communication with the reaction site, etc.), or separate from the device in some cases (e.g., within sensing communication). Also, the sensor may be integrally connected to or separate from the reaction site in certain embodiments.

As used herein, an “environmental factor” or an “environmental condition” is a detectable and/or measurable condition (e.g., by a sensor) of the environment within and/or associated with a reaction site, such as the temperature or pressure. The factor or condition may be detected and/or measured within the reaction site, and/or at a location proximate to the reaction site (e.g., upstream or downstream of the reaction site) such that the environmental condition within the reaction site is known and/or controlled. For example, the environmental factor may be the concentration of a gas or a dissolved gas within the reaction site or associated with the reaction site (for example, upstream or downstream of the reaction site, separated from the reaction site by a membrane, etc.). The gas may be, for example, oxygen, nitrogen, water (i.e., the relative humidity), CO₂, or the like. The environmental factor may also be a concentration of a substance in some cases. For example, the environmental factor may be an aggregate quantity, such as molarity, osmolarity, salinity, total ion concentration, pH, color, optical density, or the like. The concentration may also be the concentration of one or more compounds present within the reaction site, for example, an ion concentration such as sodium, potassium, calcium, iron or chloride ions; or a concentration of a biologically active compound, such as a protein, a lipid, or a carbohydrate source (e.g., a sugar) such as glucose, glutamine, pyruvate, apatite, an amino acid or an oligopeptide, a vitamin, a hormone, an enzyme, a-protein, a growth factor, a serum, or the like. In some embodiments, the substance within the reaction site may include one or more metabolic indicators, for example, as would be found in media, or as produced as a waste products from cells. If cells are present, the sensor may also be a sensor for determining all viability, cell density, cell motility, cell differentiation, cell production (e.g., of proteins, lipids, small molecules, drugs, etc.), etc.

The environmental factor may also be a fluid property of a fluid within the reaction site, such as the pressure, the viscosity, the turbidity, the shear rate, the degree of agitation, or the flowrate of the fluid. The fluid may be, for instance, a liquid or a gas. In one set of embodiments, the environmental factor is an electrical state, for example, the charge, current, voltage, electric field strength, or resistivity or conductivity of the fluid or another substance within the reaction site. In one set of embodiments, the environmental condition is temperature or pressure. In certain embodiments, the sensor may be a ratiometric sensor, i.e., a sensor able to determine a difference or ratio between two (or more) signals, e.g., a measurement and a control signal, two measurements, etc.

Non-limiting examples of sensors useful in the invention include dye-based detection systems, affinity-based detection systems, microfabricated gravimetric analyzers, CCD cameras, optical detectors, optical microscopy systems, electrical systems, thermocouples and thermistors, pressure sensors, etc. Those of ordinary skill in the art will be able to identify other sensors for use in the invention. For example, in one set of embodiments, the device may contain a sensor comprising one or more detectable chemicals responsive to one or more environmental factors, for example, a dye (or a combination of dyes), a fluorescent molecule, etc. One or more dyes, or fluorescent or chromogenic molecules sensitive to a specific environmental condition(s) may be chosen by those of ordinary skill in the art. Non-limiting examples of such dyes, or fluorescent or chromogenic molecules include pH-sensitive dyes such as phenol red, bromothymol blue, chlorophenol red, fluorescein, HPTS, 5(6)-carboxy-2′,7′-dimethoxyfluorescein SNARF, and phenophthalein; dyes sensitive to calcium such as Fura-2 and Indo-1; dyes sensitive to chloride such as 6-methoxy-N-(3-sulfopropyl)-quinolinium and lucigenin; dyes sensitive to nitric oxide such as 4-amino-5-methylamino-2′,7′-difluorofluorescein; dyes sensitive to dissolved oxygen such as tris(4,4′-diphenyl-2,2′-bipyridine) ruthenium (II) chloride pentahydrate; dyes sensitive to dissolved CO₂; dyes sensitive to fatty acids, such as BODIPY 530-labeled glycerophosphoethanolamine; dyes sensitive to proteins such as 4-amino-4′-benzamidostilbene-2-2′-disulfonic acid (sensitive to serum albumin), X-Gal or NBT/BCIP (sensitive to certain enzymes), Tb^{3 +} from TbCl₃ (sensitive to certain calcium-binding proteins), BODIPY FL phallacidin (sensitive to actin), or BOCILLIN FL (sensitive to certain penicillin-binding proteins); dyes sensitive to concentration of glucose, lactose or other components, or dyes sensitive to proteases, lactates or other metabolic byproducts, dyes sensitive to proteins, antibodies, or other cellular products, such as calcein AM, ethidium bromide, or resazurin (sensitive to viability).

In one embodiment, the dye or fluorescent molecule may be immobilized within one or more walls within the device, e.g., within one or more walls defining the reaction site. In another embodiment, the dye or fluorescent molecule may be immobilized within a gel positioned within the device, for example, in fluid communication with the reaction site. In yet another embodiment, the dye or fluorescent molecule may be dissolved in a media, for example, that is passed through the reaction site. The dye or fluorescent molecule may have a response generally proportional to a value of one or more environmental factors and/or other variable(s) of interest. The response may be measured, e.g., as a fluorescent signal, an absorbance signal, a wavelength or frequency, etc. A reactor and/or reaction site within a device may be coupled to a light delivery and/or other light interacting component(s). For example, the light-interacting component may include a detection system where light (e.g., having a predetermined wavelength) arising from a dye, a fluorescent molecule, etc., may be detected and/or measured.

The sensor can include a calorimetric detection system in some cases, which may be external to the device, or microfabricated into the device in certain cases. In one embodiment, the calorimetric detection system can be external to the device, but optically coupled to the reaction site, for example, using fiber optics or other light-interacting components that may be embedded in the device (e.g., such as those described below). As an example of a calorimetric detection system, if a dye or a fluorescent molecule is used, the calorimetric detection system may be able to detect a change or shift in the frequency and/or intensity of the dye or fluorescent molecule in response to a change or shift in one or more environmental factors within a reaction site. As a specific example, Ocean Optics Inc. (Dunedin F.O.) provides fiber optic probes and spectrometers for the measurement of pH and dissolved oxygen concentration.

In some aspects of the invention, any of the above-described devices may be constructed and arranged such that the device, or a portion thereof, such as-one or more reaction sites, is able to respond to a change in an environmental condition within or associated with a reaction site, for example, by use of a control system. In some cases, each reaction site within the device may be independently controlled in some fashion. As used herein, a “control system” is a system able to detect and/or measure one or more environmental factors within or associated with the reaction site, and cause a response or a change in the environmental conditions within or associated with the reaction site (for instance, to maintain an environmental condition at a certain value). In some cases, the control system may control the environmental factor in real time. The response produced by the control system may be based on the environmental factor in certain cases. An “active” control system, as used herein, is a system able to cause a change in an environmental factor associated with a reaction site as a direct response to a measurement of the environmental condition. The active control system may provide an agent that can be delivered, or released from the reaction, where the agent is controlled in response to a sensor able to determine a condition associated with the reaction site. A “passive” control system, as used herein, is a system able to maintain or cause a change in an environmental condition of the reaction site without requiring a measurement of an environmental factor. The passive control system may control the environmental factor within the reaction site, but not necessarily in response to a sensor or a measurement. The passive control system may allow an agent to enter or exit the reaction site without active control. For example, a passive control system may include an oxygen membrane and/or a water-permeable membrane, where the membrane can maintain the oxygen and/or the water vapor content within the reaction site, for instance, within certain predetermined limits. The control system may be able to control one or more conditions within or associated with the reaction site for any length of time, for example, 1 day, 1 week, 30 days, 60 days, 90 days, 1 year, or indefinitely in some cases.

The control system can include a number of control elements, for example, a sensor operatively connected to an actuator, and optionally to a processor. One or more of the components of the control system may be integrally connected to the device containing the reaction site, or separate from the device. In some cases, the control system includes components that are integral to the device and other components that are separate from the device. The components may be within or proximate to the reaction site (e.g., upstream or downstream of the reaction site, etc.). Of course, in some embodiments, the control system may include more than one sensor, processor, and/or actuator, depending on the application and the environmental factor(s) to be detected, measured, and/or controlled.

The methods of the present invention may be used to enhance or alter the performance of reactions in a variety of reactors. In particular, the methods may be used with cellular bioreactions that use reactors and systems for the culture of eukaryotic and/or prokaryotic organisms, and/or cell cultures derived from animals, insects, plants, bacteria, fungi, or yeast.

A reactant can be any suitable composition that can undergo a chemical, biological, and/or biochemical reaction. Non-limiting examples of reactants include cells (e.g., eukaryotic and prokaryotic cells), portions of cells (e.g., a cell membrane), nutrients, proteins (e.g., antibodies), metabolites, polymers (including polymer components such as monomers, oligomers, and cross-linking agents), and chemical reagents. Reactants may be present in solution, in suspension, attached to a portion (e.g., a surface) of the reaction site, and/or attached to solid phase carriers in the reaction site, i.e., during formation of the product.

Examples of carrier systems include microcarriers (e.g., polymer spheres, microbeads, and microdisks that can be porous or non-porous), cross-linked beads (e.g., dextran) charged with specific chemical groups (e.g., tertiary amine groups), 2D microcarriers including cells trapped in nonporous polymer fibers, 3D carriers (e.g., carrier fibers, hollow fibers, multicartridge reactors, and semi-permeable membranes that can comprising porous fibers), microcarriers having reduced ion exchange capacity, encapsulation cells, capillaries, and aggregates. Carriers can be fabricated from materials such as dextran, gelatin, glass, and cellulose.

The reactions may include culture systems where cells are in contact with moving liquids and/or gas bubbles. Bioreactors of this type include, for example, stirred tank fermentors or bioreactors agitated by rotating mixing devices, chemostats, bioreactors agitated by shaking devices, airlift fermentors/bioreactors, fluidized bed bioreactors, bioreactors employing wave induced agitation, centrifugal bioreactors, roller bottles or other systems for the culture of animal or insect cells attached to polymer (such as plastic) surfaces, hollow fiber bioreactors, and microfluidic reactors comprising a “gas head space”.

A variety of different cells can be cultured in large- and small-scale reactors and/or in small-scale reactors in connection with optimization and/or other study or modification of a large-scale process in accordance with the invention. For instance, cell cultures can be derived from sources such as animals (e.g., hamsters, mice, pigs, rabbits, dogs, and humans), insects (e.g., moths and butterflies), plants (e.g., corn, tomato, rice, wheat, barley, alfalfa, sugarcane, soybean, potato, lettuce, lupine, tobacco, rapeseed (canola), sunflower, turnip, arabidopsis thaliana, taxus cuspidata, catharanthus roseus, beet cane molasses, seeds, safflower, and peanuts), bacteria, fungi, and yeast.

Non-limiting examples of animal cells include Chinese hamster ovary (CHO), mouse myeloma, MO035 (NSO cell line), hybridomas (e.g., B-lymphocyte cells fused with myeloma tumor cells), baby hamster kidney (BHK), monkey COS, African green monkey kidney epithelial (VERO), mouse embryo fibroblasts (NIH-3T3), mouse connective tissue fibroblasts (L929), bovine aorta endothelial (BAE-1), mouse myeloma lymphoblastoid-like (NS0), mouse B-cell lymphoma lymphoblastoid (WEHI 231), mouse lymphoma lymphoblastoid (YAC 1), mouse fibroblast (LS), hepatic mouse (e.g., MC/9, NCTC clone 1469), and hepatic rat cells (e.g., ARL-6, BRL3A, H4S, Phi 1 (from Fu5 cells)).

Cells from humans can include cells such as retinal cells (PER-C6), embryonic kidney cells (HEK-293), lung fibroblasts (MRC-5), cervix epithelial cells (HELA), diploid fibroblasts (WI38), kidney epithelial cells (HEK 293), liver epithelial cells (HEPG2), lymphoma lymphoblastoid cells (Namalwa), leukemia lymphoblastoid-like cells (HL60), myeloma lymphoblastoid cells (U 266B1), neuroblastoma neuroblasts (SH-SY5Y), diploid cell strain cells (e.g., propagation of poliomyelitis virus), pancreatic islet cells, embryonic stem cells (hES), human mesenchymal stem cells (MSCs, which can be differentiated to osteogenic, chondrogenic, tenogenic, myogenic, adipogenic, and marrow stromal lineages, for example), human neural stem cells (NSC), human histiocytic lymphoma lymphoblastoid cells (U937), and human hepatic cells such as WRL68 (from embryo cells), PLC/PRF/5 (i.e., containing hepatitis B sequences), Hep3B (i.e., producing plasma proteins: fibrinogen, alpha-fetoprotein, transferrin, albumin, complement C3 and/or aplpha-2-macroglobulin), and HepG2(i.e., producing plasma proteins: prothrombin, antithrombin III, alpha-fetoprotein, complement C3, and/or fibrinogen).

In some instances, cells from insects (e.g., baculovirus and Spodoptera frugiperda ovary (Sf21 cells produce Sf9 line)) and cells from plants and/or food can be cultured. For instance, cells from sources such as rice (e.g., Oryza sativa, Oryza sativa cv Bengal callus culture, and Oryza sativa cv Taipei 309), soybean (e.g., Glycine max cv Williams 82), tomato (Lycopersicum esculentum cv Seokwang), and tobacco leaves (e.g., Agrobacterium tumefaciens including Bright Yellow 2 (BY-2), Nicotiana tabacum cv NT-1, N. tabacum cv BY-2, and N. tabacum cv Petite Havana SR-1) can be cultured in various types of bioreactors as described herein.

In other instances, cells from various sources of bacteria, fungi, or yeast can be cultured in bioreactor systems. Non-limiting examples of bacteria include Salmonella, Escherichia coli, Vibrio cholerae, Bacillus subtilis, Streptomyces, Pseudomonas fluorescens, Pseudomonas putida, Pseudomonas sp, Rhodococcus sp, Streptomyces sp, and Alcaligenes sp. Fungal cells can be cultured from species such as Aspergillus niger and Trichoderma reesei, and yeast cells can include cells from Hansenulapolymorpha, Pichia pastoris, Saccharomyces cerevisiae, S. cerevisiae crossed with S. bayanus, S. cerevisiae crossed with LAC4 and LAC12 genes from K. lactis, S. cerevisiae crossed. with Aspergillus shirousamii, Bacillus subtilis, Saccharomyces diastasicus, Schwanniomyces occidentalis, S. cerevisiae with genes from Pichia stipitis, and Schizosaccharomyces pombe.

In some cases, it may be appropriate to add additives (e.g., nutrients and enzymes) to cells being cultured in a bioreactor. Non-limiting examples of additives include amino acids, bovine serum albumin, growth factors (e.g., hepatocyte growth factor), inhibitors (e.g., protease inhibitors), fatty acids, lipids, hormones (e.g., dexamethasone and gibberellic acid), trace elements, inorganic compounds (e.g., reducing manganese), stabilizing agents (e.g., dimethylsulfoxide), polyethylene glycol, polyvinylpyrrolidone (PVP), gelatin, antibiotics (e.g., Brefeldin A), salts (e.g., NaCl), chelating agents (e.g., EDTA, EGTA), and enzymes (e.g., dispase, hyaluronidase, and DNAase).

Reaction parameters can include, for example, chemical concentration, mechanical treatment, temperature and light. Some of the reaction parameters that can be evaluated/determined/transferred include, for example: temperature, pH, shear stress, shear rate, dissolved gases, such as oxygen concentration and CO₂ concentration, nutrient concentrations, metabolite concentrations, glucose concentration, glutamine concentration, pyruvate concentration, apatite concentration, relative humidity, molarity, osmolarity, color, turbidity, viscosity, a concentration of an amino acid, a concentration of a vitamin, a concentration of a hormone, concentration of an additive, serum concentration, ionic strength, a concentration of an ion, degree of agitation, pressure, and a concentration of an oligopeptide, flow rate, light, cell condition, etc.

These reaction parameters and others may be optimized using microbioreactors and then reproduced in a large scale bioreactor to achieve or approach the results obtained in the microbioreactions according to certain embodiments presented herein.

A variety of different end products can be produced in large- and micro-scale bioreactors and/or in micro-scale bioreactors in connection with optimization and/or other study or modification of a large-scale process in accordance with the invention. Products of a bioreactor can include proteins (i.e., antibodies and enzymes), amino acids, nucleic acids, oligonucleotides, anti-inflammatory compounds, antiparasitic agents, antibiotics, polypeptides, steroids, polysaccharides, lipids, proteoglycans, polymers, organic acids, vaccines, viral products (including anitviral products), hormones, immunoregulators, metabolites, fatty acids, vitamins, chemotherapeutic drugs, antibiotics, cells, and tissues.

Non-limiting examples of proteins include human therapeutic proteins, monoclonal antibodies, enzymes, human tissue plasminogen activators (tPA), blood coagulation factors, growth factors (e.g., cytokines, including interferons and chemokines), adhesion molecules, Bcl-2 family of proteins, polyhedrin proteins, human serum albumin, human erythropoietin, mouse monoclonal heavy chain y, mouse IgG_{2b/K}, mouse IgG₁, heavy chain mAb, Bryondin 1, human interleukin-2, human interleukin-4, ricin, human α1-antitrypisin, antibody fragments (e.g., biscFv and scFv antibody fragments), immunoglobulins, human granulocyte, stimulating factor (hGM-CSF), hepatitis B surface antigen (HBsAg), human lysozyme, IL-12, and mAb against HBsAg. Examples of plasma proteins include fibrinogen, alpha-fetoprotein, transferrin, albumin, complement C3 and aplpha-2-macroglobulin, prothrombin, antithrombin III, alpha-fetoprotein, complement C3 and fibrinogen, insulin, hepatitis B surface antigen, urate oxidase, glucagon, granulocyte-macrophage colony stimulating factor, hirudin/desirudin, angiostatin, elastase inhibitor, endostatin, epidermal growth factor analog, insulin-like growth factor-1, kallikrein inhibitor, α-1 antitrypsin, tumor necrosis factor, collagen protein domains (but not whole collagen glycoproteins), proteins without metabolic byproducts, human albumin, bovine albumin, thrombomodulin, transferrin, factor VIII for hemophilia A (i.e., from CHO or BHK cells), factor VIIa (i.e., from BHK), factor IX for hemophilia B (i.e., from CHO), human-secreted alkaline phosphatase, aprotinin, histamine, leukotrienes, IgE receptors, N-acetylglucosaminyltransferase-III, and antihemophilic factor VIII.

Enzymes can be produced from a variety of sources in bioreactors. Non-limiting examples of such enzymes include YepACT-AMY-ACT-X24 hybrid enzyme from yeast, Aspergillus oryzae α-amylase, xylanases, urokinase, tissue plasminogen activator (rt-PA), bovine chymosin, glucocerebrosidase (therapeutic enzyme for Gaucher's disease, from CHO), lactase, trypsin, aprotinin, human lactoferrin, lysozyme, and oleosines.

In some instances, vaccines can be produced in bioreactors. Non-limiting examples include vaccines for prostate cancer, human papilloma virus, viral influenza, trivalent hemagglutinin influenza, AIDS, HIV, malaria, anthrax, bacterial meningitis, chicken pox, cholera, diphtheria, haemophilus influenza type B, hepatitis A, hepatitis B, pertussis, plague, pneumococcal pneumonia, polio, rabies, human-rabies, tetanus, typhoid fever, yellow fever, veterinary-FMD, New Castle's Disease, foot and mouth disease, DNA, Venezuelan equine encephalitis virus, cancer (colon cancer) vaccines (i.e., prophylactic or therapeutic), MMR (measles, mumps, rubella), yellow fever, Haemophilus influenzae (Hib), DTP (diphtheria and tetanus vaccines, with pertussis subunit), vaccines linked to polysaccharides (e.g., Hib, Neisseria meningococcus), Staphylococcus pneumoniae, nicotine, multiple sclerosis, bovine spongiform encephalopathy (mad cow disease), IgG1 (phosphonate ester), IgM (neuropeptide hapten), SIgA/G (Streptococcus mutans adhesin), scFv-bryodin 1 immunotoxin (CD-40), IgG (HSV), LSC (HSV), Norwalk virus, human cytomegalovirus, rotavirus, respiratory syncytial virus F, insulin-dependent autoimmune mellitus diabetes, diarrhea, rhinovirus, herpes simplex virus, and personalized cancer vaccines, e.g., for lymphoma treatment (i.e., in injectable, oral, or edible forms). In some cases, recombinant subunit vaccines can be produced, such as hepatitis B virus envelope protein, rabies virus glycoprotein, E. coli heat labile enterotoxin, Norwalk virus capsid protein, diabetes autoantigen, cholera toxin B subunit, cholera toxin B an dA2 subunits, rotavirus enterotoxin and enterotoxigenic E. coli, fimbrial antigen fusion, and porcine transmissible gastroenteritis virus glycoprotein S.

It may be desirable, in some cases, to produce viral products in bioreactors. Non-limiting examples of viral products include sindbis, VSV, oncoma, hepatitis A, channel cat fish virus, RSV, corona virus, FMDV, rabies, polio, reo virus, measles, and mumps.

Hormones are another class of end products that can be produced in large-scale and/or micro-scale bioreactors. Non-limiting examples of hormones include growth hormone (e.g., human growth hormone (hGH) and bovine growth hormone), growth factors, beta and gamma interferon, vascular endothelial growth factor (VEGF), somatostatin, platelet-derived growth factor (PDGF), follicle stimulating hormone (FSH), luteinizing hormone, human chorionic hormone, and erythropoietin.

Immunoregulators can also be produced in bioreactors. Non-limiting examples of immunoregulators include interferons (e.g., beta-interferon (for multiple sclerosis), alpha-interferon, and gamma-interferon) and interleukins (such as IL-2).

Metabolites (e.g., shikonin and paclitaxel) and fatty acids (i.e., including straight-chain (e.g., adipic acid, Azelaic acid, 2-hydroxy acids), branched-chain (e.g., 10-methyl octadecanoic acid and retinoic acid), ring-including fatty acids (e.g., coronaric acid and lipoic acid), and complex fatty acids (e.g., fatty acyl-CoA) can also be produced in bioreactors.

In some instances, commercial products, which can be used for treating various conditions, can be produced in bioreactors. Non-limiting examples of such products include Epogen® (i.e., for treating anemia), CamPath® (i.e., for treating chronic lymphocytic leukemia), Herceptin® (i.e., for treating metastatic breast cancer), Mylotarg® (i.e., for treating acute myeloid leukemia), Synagis® (i.e., for treating lower respiratory tract disease caused by respiratory syncytial virus (RSV)), Zenapax® (an immunosuppressive agent, i.e., for preventing organ rejection), Enbrel® (i.e., for treating conditions such as rheumatoid arthritis and ankylosing spondylitis), Humira® (i.e., for treating rheumatoid arthritis), Orthoclone OKT3® (i.e., for preventing organ rejections such as allograft rejections), Remicade® (i.e., for treating rheumatoid arthritis and Crohn's disease), ReoPro® (i.e., for preventing acute thrombosis from percutaneous transluminal coronary angioplasty (PTCA)), Rituxan® (for treating non-Hodgkin's lymphoma), and Simulect® (i.e., for the prophylaxis of acute organ rejection in patients receiving renal transplantation).

Different methods of producing end products can be implemented in bioreactors. In some embodiments, manipulation of gene expression in cells can be performed, and the cells can be cultured in bioreactors to produce one or more products (e.g., proteins) as a result of changes in expression. Different cell types and/or different reaction conditions within the bioreactor, for example, can influence the production of the end product. Methods for manipulation of gene expression can include transfection (i.e., infection of a cell with isolated viral nucleic acid followed by production of the complete virus in the cell), replacement of genes in cells, insertion of genes in cells (e.g., in plants cells using methods such as agrobacterium-mediated transformation, particle bombardment (biolistics), insertion into the separate genome of plastids (e.g., chloroplasts and mitochondria), chloroplast transformation in tobacco, potato, tomato, etc.), and recombinant DNA technologies such as PCR, DNA shuffling, and site-directed mutagenesis.

Other processes including xenotransplantation (e.g., transferring cells, tissues, or organs from an animal to cells, tissues, or organs from a human) and transdifferentiation (i.e., of multipotent stem cells) can also be performed in bioreactors.

The following examples are intended to illustrate certain embodiments of the present invention, but are not to be construed as limiting and do not exemplify the full scope of the invention.

### EXAMPLE 1

This example shows a comparison between a standard fed-batch process and a substantially constant volume fed-batch process according to certain embodiments of the invention. A standard fed-batch culture of Chinese hamster ovary (CHO) cells was preformed in a reaction site of a shake flask. Under standard fed-batch conditions, the initial reaction site volume was 76% of the final volume. The final reaction site volume was 25 mL. There were four feeds on days 1, 3, 5, and 6 of the culture in which cell nutrients were added to the reaction site. Each feed was 8% of the initial volume. Accordingly, the initial volume of the flask was 19 mL and each feed was 1.5 mL.

A substantially constant volume fed-batch process was performed in a reaction site of a shake flask. The initial and final volumes in the reaction site were 25 mL, and there were four feeds on days 1, 3, 5, and 6 of the culture in which cell nutrients were added to the reaction site. During the days of feeding, a homogeneous portion of fluid was removed from the reaction site prior to the addition of the feed. The feeding strategy was adjusted to accommodate for the differences in volume of the two methods. The following table illustrates the feeding strategy for the standard and substantially constant volume fed-batch processes.

| | | | | | “Substantially constant volume” | | | |
|---|---|---|---|---|---|---|---|---|
| | Standard Fed-batch | | | | fed-batch | | | |
| | Vᵢ | V_{feed} | V_{f} | | Vᵢ | V_{removed} | V_{added} | V_{f} |
| Day | (mL) | (mL) | (mL) | d | (mL) | (mL) | (mL) | (mL) |
| 0 | 19 | 0 | 19 | 0 | 25 | 0 | 0 | 25 |
| 1 | 19 | 1.5 | 20.5 | 0.073 | 25 | 1.825 | 1.825 | 25 |
| 2 | 20.5 | 0 | 20.5 | 0 | 25 | 0 | 0 | 25 |
| 3 | 20.5 | 1.5 | 22 | 0.068 | 25 | 1.7 | 1.7 | 25 |
| 4 | 22 | 0 | 22 | 0 | 25 | 0 | 0 | 25 |
| 5 | 22 | 1.5 | 23.5 | 0.064 | 25 | 1.6 | 1.6 | 25 |
| 6 | 23.5 | 1.5 | 25 | 0.060 | 25 | 1.5 | 1.5 | 25 |
| 7 | 25 | 0 | 25 | 0 | 25 | 0 | 0 | 25 |

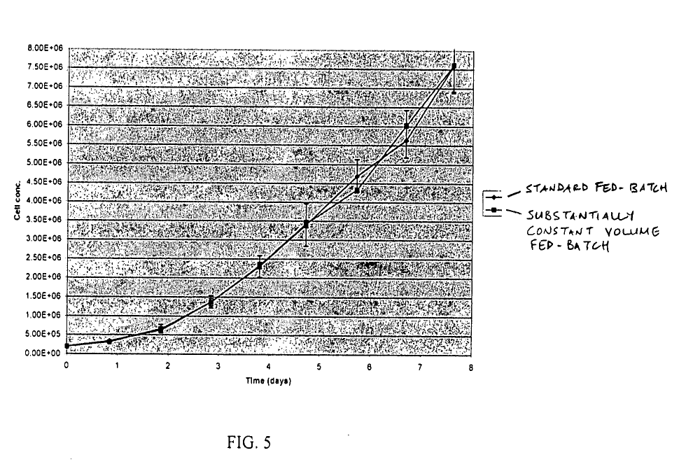

FIG. 5 shows a comparison of the growth curves of the CHO cells following the two feeding strategies. As illustrated in FIG. 5, there were no significant differences in the growth curves and cell densities of the two methods. This is because during the substantially constant volume method, homogeneous samples were removed; this process did not alter the concentrations of the cells, or nutrients, in the reaction site.

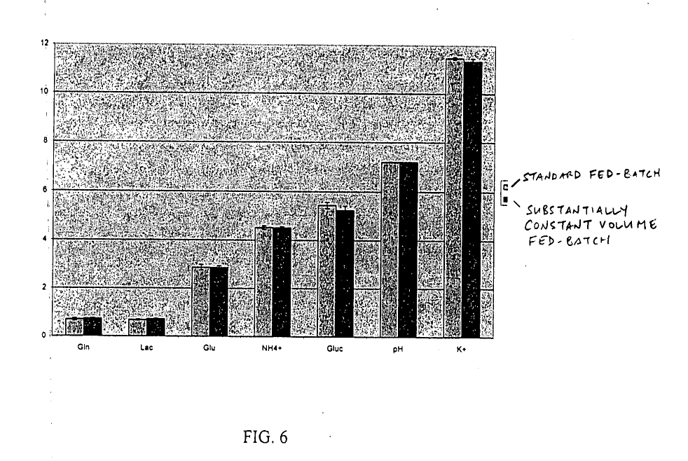

FIG. 6 shows that the nutrient concentrations in the reaction sites after the addition of the feeds is substantially similar using both the standard and substantially constant volume fed-batch methods. This example illustrates that the substantially constant volume method can be designed to mimic traditional fed-batch processes where the reaction volume increases with each feed addition.

### EXAMPLE 2

This example shows a comparison between a standard fed-batch process and a substantially constant volume fed-batch process performed in microbioreactors according to certain embodiments of the invention. The feeding strategy was similar to that in Example 1 but the final volume of the reaction mixture was 620 microliters. The associated volumes for this experiment are given in the table below.

| | | | | | “Substantially constant volume” | | | |
|---|---|---|---|---|---|---|---|---|
| | Standard Fed-batch | | | | fed-batch | | | |
| | Vᵢ | V_{feed} | V_{f} | | Vᵢ | V_{removed} | V_{added} | V_{f} |
| Day | (μL) | (μL) | (μL) | d | (μL) | (μL) | (μL) | (μL) |
| 0 | 471 | 0 | 471 | 0 | 620 | 0 | 0 | 620 |
| 1 | 471 | 37.2 | 508.2 | 0.073 | 620 | 45.4 | 45.4 | 620 |
| 2 | 508.2 | 0 | 508.2 | 0 | 620 | 0 | 0 | 620 |
| 3 | 508.2 | 37.2 | 545.4 | 0.068 | 620 | 42.3 | 42.3 | 620 |
| 4 | 545.4 | 0 | 545.4 | 0 | 620 | 0 | 0 | 620 |
| 5 | 545.4 | 37.2 | 582.6 | 0.064 | 620 | 39.6 | 39.6 | 620 |
| 6 | 582.6 | 37.2 | 619.8 | 0.060 | 620 | 37.2 | 37.2 | 620 |
| 7 | 619.8 | 0 | 619.8 | 0 | 620 | 0 | 0 | 620 |

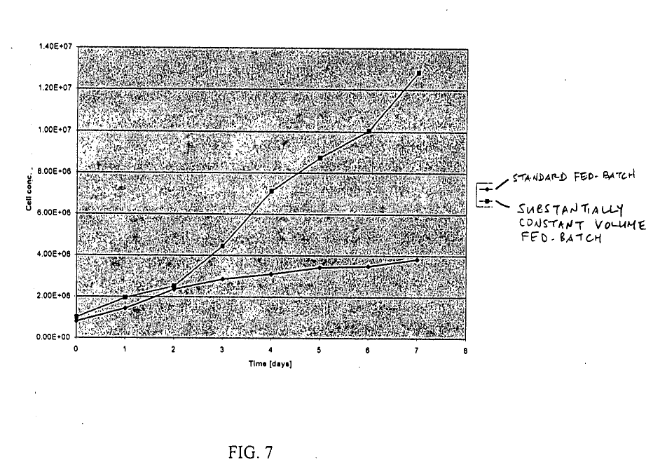

The results of this experiment are shown in FIG. 7. In this case, the results of the two methods were different because in the standard fed-batch method, the initial volume of fluid in the microbioreactor was well below the optimal value for good cell growth. This dramatically affected the culture and resulted in poor growth, even after the volume was increased to optimal levels on later days. In contrast, the substantially constant volume fed-batch method resulted in sustained growth throughout the course of the experiment. This is a result of constantly operating the microbioreactor at an optimal volume (e.g., between 80-90% of the reaction site volume). Additionally, the cell densities, growth rates, and nutrient and metabolite profiles of the microbioreactor operated in the substantially constant volume mode compared favorably with those in the shake flask as described in Example 1.

This example shows the usefulness of the substantially constant volume approach for conducting fed-batch comparisons when the prescribed protocol is not conducive for use in scaled-down systems. As such, the methods provided herein can allow parameters of large scale reactors to be correlated with those of small scale reactors. In addition, these methods can enable reactors to be operated at optimal volumes throughout the course of forming the product.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of forming a product in a reaction site and controlling fluid volume in the site, comprising:
providing a reaction site having a reaction site volume of less than 2 mL and containing a first volume of fluid including a reactant, wherein the first volume is greater than 80%, but less than 95%, of the reaction site volume;
forming a product from the reactant in the reaction site;
removing from the reaction site a portion of fluid, homogenous with respect to fluid remaining in the reaction site after removal, such that the concentration of the reactant in the portion removed is substantially equivalent to the concentration of the reactant in the fluid remaining in the reaction site after removal; and
introducing a second volume of fluid into the reaction site,
wherein the volume of fluid remaining in the reaction site, after removing the portion of fluid and introducing the second volume, is within 10% of the first volume.

2. A method as in claim 1, wherein the volume of fluid remaining in the reaction site, after removing the portion of fluid and introducing the second volume, is within 7% of the first volume.

3. A method as in claim 1, wherein the volume of fluid remaining in the reaction site, after removing the portion of fluid and introducing the second volume, is within 5% of the first volume.

4. A method as in claim 1, wherein the volume of fluid remaining in the reaction site, after removing the portion of fluid and introducing the second volume, is within 3% of the first volume.

5. A method as in claim 1, wherein the volume of fluid remaining in the reaction site, after removing the portion of fluid and introducing the second volume, is substantially equivalent to the first volume.

6. A method as in claim 1, wherein the first volume is maintained throughout the course of forming the product.

7. A method as in claim 1, wherein removing the portion of fluid is performed before introducing the second volume.

8. A method as in claim 1, wherein removing the portion of fluid is performed after introducing the second volume.

9. A method as in claim 1, further comprising maintaining a substantially constant level of shear within the fluid in the reaction site during the course of forming the product, wherein the substantially constant level of shear is non-zero.

10. A method as in claim 1, wherein the concentration of a reactant and/or product in the reaction site is maintained within a range that provides results allowing the concentration to be transferred to a large scale reactor with a corresponding effect on large scale reactor results.

11. A method as in claim 1, wherein the reaction site volume is less than or equal to 1.2 mL.

12. A method as in claim 1, wherein the reaction site comprises at least one microfluidic channel in fluid communication with the reaction site.

13. A method as in claim 1, further comprising introducing a third volume of fluid into the reaction site and removing from the reaction site a second portion of fluid, homogenous with respect to fluid remaining in the reaction site after removal of the second portion, such that the concentration of the reactant in the second portion removed is substantially equivalent to the concentration of the reactant in the fluid remaining in the reaction site after removal of the second portion, wherein the volume of fluid remaining in the reaction site, after removing the second portion and introducing the third volume, is greater than 80% but less than 95% of the reaction site volume.

14. A method as in claim 1, wherein the reactant comprises a cell.

15. A method as in claim 14, wherein the cell is a mammalian cell.

16. A method as in claim 14, wherein the cell is a bacterial cell.

17. A method as in claim 14, wherein the cell is an insect cell.

18. A method as in claim 14, wherein the cell is a plant cell.

19. A method as in claim 1, wherein the reactant comprises a cell component.

20. A method as in claim 1, wherein the reactant comprises a nutrient.

21. A method as in claim 1, where the product comprises a cellular product.

22. A method as in claim 1, wherein the product comprises a plurality of cells.

23. A method as in claim 1, wherein the product comprises a tissue.

24. A method as in claim 1, wherein the product comprises at least one of a vitamin, amino acid, nucleic acid, oligonucleotide, anti-inflammatory compound, antiparasitic agent, antiviral compound, cytokine, antibiotic, hormone, polypeptide, steroid, chemotherapeutic drug, polysaccharide, lipid, proteoglycan, polymer, protein, carbohydrate, an organic acid, or a combination of any of these.

25. A method as in claim 24, wherein the protein comprises at least one of a human therapeutic protein, monoclonal antibody, antibody fragment, growth factor, an enzyme, or a combination of any of these.

26. A method as in claim 14, wherein the cell is suspended in the first volume of fluid during formation of the product.

27. A method as in claim 14, wherein the cell is attached to a surface in the reaction site during the formation of the product.

28. A method as in claim 1, further comprising determining a property of the portion of fluid removed from the reaction site.

29. A method as in claim 28, wherein the property is a concentration of the reactant.

30. A method as in claim 28, wherein the property is a concentration of the product.

31. A method as in claim 1, wherein the reaction site contains a shear-generating element.

32. A method as in claim 31, wherein the shear-generating element is an air bubble or a solid disc.

33. A method as in claim 31, wherein the sum of the first volume and the volume of the shear-generating element is substantially equivalent to the reaction site volume.

34. A method as in claim 1, wherein the reaction site is in communication with a pH sensor.

35. A method as in claim 34, wherein the pH sensor controls pH of fluid in the reaction site.

36. A method as in claim 1, wherein the reaction site is in fluid communication with an auxiliary chamber via a semi-permeable membrane.

37. A method of forming a product in a reaction site and controlling fluid volume in the site, comprising:
providing a reaction site having a reaction site volume of less than 2 mL and containing a first volume of fluid including a reactant, wherein the first volume is greater than 80%, but less than 95%, of the reaction site volume;
forming a product from the reactant in the reaction site;
introducing a second volume of fluid into the reaction site; and
removing a portion of fluid from the reaction site such that the volume of fluid remaining in the reaction site, after removing the portion of fluid and introducing the second volume, is greater than 80% but less than 95% of the reaction site volume.

38. A method as in claim 37, wherein the volume of the portion of fluid removed from the reaction site is substantially equivalent to the second volume so as to maintain the first volume in the reaction site.

39. A method as in claim 37, wherein removing a portion of fluid from the reaction site comprises removing a portion of fluid homogenous with respect to fluid remaining in the reaction site after removal, such that the concentration of the reactant in the portion removed is substantially equivalent to the concentration of the reactant in the fluid remaining in the reaction site after removal.

40. A method of forming a product in a reaction site and controlling fluid volume in the site, comprising:
providing a reaction site having a reaction site volume and containing a first volume of fluid including a reactant;
forming a product from the reactant in the reaction site;
removing from the reaction site a portion of fluid, homogenous with respect to fluid remaining in the reaction site after removal, such that the concentration of the reactant in the portion removed is substantially equivalent to the concentration of the reactant in the fluid remaining in the reaction site after removal; and
introducing a second volume of fluid into the reaction site, wherein the second volume is substantially equivalent to the volume of the portion removed so as to maintain the first volume in the reaction site.

41. A method as in claim 40, wherein the first volume is substantially equivalent to the reaction site volume.

42. A method of forming a product in a reaction site and controlling fluid volume in the site, comprising:
providing a reaction site having a reaction site volume of less than 2 mL and containing a first volume of fluid including a reactant;
forming a product from the reactant in the reaction site;
removing a portion of fluid from the reaction site;
introducing a second volume of fluid into the reaction site, wherein the second volume is substantially equivalent to volume of the portion removed so as to maintain the first volume in the reaction site; and
maintaining a substantially constant level of shear during the course of forming the product, wherein the substantially constant level of shear is non-zero.

43. A method as in claim 42, wherein the first volume is substantially equivalent to the reaction site volume.
